(19) United States
(12) Patent Application Publication
(10) Pub. No.: US 2015/0138144 A1
(43) Pub. Date: May 21, 2015

(54) COORDINATE INPUT DEVICE AND MOBILE TERMINAL

(71) Applicant: Renesas Electronics Corporation, Kawasaki-shi (JP)

(72) Inventor: Akira TANABE, Kanagawa (JP)

(73) Assignee: Renesas Electronics Corporation, Kawasaki-shi (JP)

(21) Appl. No.: 14/518,086

(22) Filed: Oct. 20, 2014

(30) Foreign Application Priority Data
Nov. 19, 2013 (JP) 2013-238498

(51) Int. Cl. G06F 3/045

(52) U.S. Cl. CPC G06F 3/045
USPC 345/174

(57) ABSTRACT

A coordinate input device 100 includes a signal generation unit 1, a transmitting antenna unit 2, a receiving antenna 3, and a detection unit 4. The transmitting antenna unit 2 includes a plurality of antennas that transmits an electromagnetic wave W according to an AC signal. The signal generation unit 1 outputs the AC signal SIG to one of the plurality of antennas of the transmitting antenna unit 2. The receiving antenna 3 receives the electromagnetic wave W from the transmitting antenna unit 2. The detection unit 4 obtains an intensity distribution of the electromagnetic wave W corresponding to the positions of a plurality of antennas based on the electromagnetic wave W received by the receiving antenna 3, and detects a detection position according to the position of a peak in the intensity distribution.

### CROSS-REFERENCE TO RELATED APPLICATIONS

This application is based upon and claims the benefit of priority from Japanese patent application No. 2013-238498, filed on Nov. 19, 2013, the disclosure of which is incorporated herein

### BACKGROUND

The present invention relates to a coordinate input device and a mobile terminal. For example, the present invention relates to a coordinate input device incorporated into a touch panel, and a mobile terminal including this touch panel disposed therein.

In mobile apparatuses such as smartphones and tablet PCs, which have increasingly became widespread in recent years, a coordinate input device such as a touch panel, instead of a keyboard and a mouse, is used as an input interface. A touch panel has both a display function and an input function, and therefore can realize an input interface that is easier to understand and to use than the keyboard and the mouse and can be used more intuitively. A variety of methods have been proposed as a method for realizing a touch panel. Among them, a resistive film type (Japanese Unexamined Patent Application Publication No. S59-85584) and a capacitive type (Japanese Unexamined Patent Application Publication No. 2012-248035) are mainstream methods.

FIG. 44 is a configuration diagram showing an example of a common resistive film type touch panel 800. In the touch panel 800, a number of point-like protrusions 802 are formed on the surface of a transparent resistive sheet 801 having a uniform surface resistance. The transparent resistive sheet 801 and a transparent electrode sheet 803 are placed on top of one another, and the protrusions 802 serves as spacers that electrically isolate the transparent resistive sheet 801 and the transparent electrode sheet 803 from each other. Diode groups 808 to 811 are connected to the four sides 804 to 807, respectively, of the transparent resistive sheet 801. A switch 813 is a double-pole double-throw switch for switching a polarity. When an a-side of the switch 813 is closed, a current flows from the positive pole of a power supply 812 through the switch 813, the diode group 810, the transparent resistive sheet 801, the diode group 811, the switch 813, and to the negative pole of the power supply 812. Therefore, isoelectric lines substantially parallel to the sides 806 and 807 are formed in the transparent resistive sheet 801. When a b-side of the switch 813 is closed, a current flows from the positive pole of the power supply 812 through the switch 813, the diode group 808, the transparent resistive sheet 801, the diode group 809, the switch 813, and to the negative pole of the power supply 812. Therefore, isoelectric lines substantially parallel to the sides 804 and 805 are formed in the transparent resistive sheet 801. When a point 815 on the transparent electrode sheet 803 is pressed from above the transparent electrode sheet 803 by a pen 814, the transparent resistive sheet 801 and the transparent electrode sheet 803 comes into contact with each other at the point 815 and a point 816 on the transparent resistive sheet 801 corresponding to the point 815. Therefore, the potential at the point 816 is transferred to the transparent electrode sheet 803. The potential at the point 816 corresponds to the coordinates of the point 816. Therefore, when the potential at the point 816 is detected by a detection circuit 817, the coordinate of the pressed point are identified. The potential at the point 816 corresponds to the y-coordinate when the a-side is closed, and corresponds to the x-coordinate when the b-side is closed. Therefore, both of the x- and y-coordinates can be identified by switching the switch 813.

As described above, it is necessary to press down the resistive film and thereby deform the resistive film in the resistive film type (Japanese Unexamined Patent Application Publication No. S59-85584). Therefore, a flexible material needs to be used for the resistive film. Consequently, the surface of the touch panel is easily scratched or damaged and hence the durability of the touch panel is poor. Further, when a plurality of points are pressed by a plurality of fingers, the resulting resistance value is substantially the same as the resistance value that is obtained when only the point nearest to the resistance measuring point among the plurality of points is pressed. Therefore, it is impossible to detect touches by a plurality of fingers at the same time.

FIG. 45 is a configuration diagram showing an example of a common capacitive touch panel system 900. As shown in FIG. 45, the touch panel system 900 includes a touch panel 910 and a touch panel controller 920. The touch panel 910 includes sensors 911 on which a user performs a touch action and thereby inputs a signal. The touch panel controller 920 includes input terminals that receive a signal from the sensors 911, coordinate detection means 921 for outputting a coordinate value based on the signal input through the input terminals, and a CPU 922 that takes in coordinate information from the coordinate detection means 921 at regular intervals and outputs data to a display device. The coordinate detection means 921 includes touch action sensitivity change means 923 for changing the sensitivity to touch actions.

The sensor 911 is a capacitive sensor. When a user performs a touch action on the touch panel 901, electrodes included in the sensor 911 detect a capacitance value between a drive line and a sense line shown in FIG. 45.

The touch panel 910 includes M drive lines DLs and L sense lines SLs, and the capacitive sensors 911 are formed at their intersections. In a touch action coordinate detection operation, the coordinates of the touched point is detected by reading a change in the capacitance of the sensors caused by the touch action through the sense lines SLs while scanning the drive lines DLs. In this operation, in consideration for the case where the detected capacitance change is small, the reading operation is performed a plurality of times and the obtained signal value is increased by adding up the signals received from the touch panel for the number of times corresponding to the plurality of reading operations.

As described above, in the capacitive type (Japanese Unexamined Patent Application Publication No. 2012-248035), since the film does not need to be deformed, a rigid material can be used for the touch panel surface. Therefore, the durability of the touch panel is higher than that of the resistive film type. Further, in the capacitive type, a capacitance can be measured for each of the intersections between the lengthwise and crosswise electrodes.

Therefore, when a plurality of points on the touch panel are touched by a plurality of fingers, the position corresponding to each of the plurality of fingers can be detected.

### SUMMARY

However, the present inventors have found the following problem in the position detection in the above-described touch panel. It the above-described capacitive type, when a capacitance between a finger and an electrode is small in comparison to the capacitance between a lengthwise electrode and a crosswise electrode, the accuracy of the capacitance measurement deteriorates. Therefore, when the finger moves away from the touch panel, the position of the finger cannot be detected. For example, in the capacitive type, when a user put on a glove, the finger is away from the touch panel by a distance corresponding to the thickness of the glove. Therefore, the position of the finger cannot be detected.

The other problems of the related art and the novel features of the present invention will be understood from the descriptions of this specification and the attached drawings.

A first aspect of the present invention is a coordinate input device including: a signal generation unit that outputs an AC (Alternating Current) signal; a first transmission/reception unit including a plurality of first antennas that transmit/receive a signal according to the AC signal; a second transmission/reception unit including a second antenna that transmits/receives the signal to/from the first transmission/reception unit; and a detection unit that, when the first transmission/reception unit transmits/receives the signal, obtains an intensity distribution of the signal corresponding to positions of the plurality of first antennas and detects a detection position according to a position of a peak of the intensity distribution.

Another aspect of the present invention is a coordinate input device that detects a position of an electric conductor, including: a signal generation unit that outputs an AC signal; a first transmission/reception unit including a plurality of first antennas that transmit/receive a signal according to the AC signal; a second transmission/reception unit including a second antenna that transmits/receives the signal to/from the first transmission/reception unit; and a detection unit that, when the first transmission/reception unit transmits/receives the signal, obtains an intensity distribution of the signal corresponding to positions of the plurality of first antennas and detects the position of the electric conductor according to a position of a peak of the intensity distribution, the electric conductor being inserted between the plurality of first antennas of the first transmission/reception unit and one or a plurality of second antennas of the second transmission/reception unit.

According to the above-described exemplary embodiments, in the coordinate input device, it is possible to detect the position of an electric conductor that is located away from the coordinate input device.

### BRIEF DESCRIPTION OF THE DRAWINGS

FIG. 1 schematically shows a configuration of a coordinate input device 100 according to a first exemplary embodiment;

FIG. 2 schematically shows a configuration of a signal generation unit 1 and a transmitting antennal unit 2;

FIG. 3 is a block diagram schematically showing a configuration of a detection unit 4;

FIG. 4 schematically shows a configuration of a coordinate input device 100 in which an electric conductor is inserted between a transmitting antennal unit 2 and a receiving antenna unit 3;

FIG. 5 is a perspective view showing an example of a mobile terminal 101 in which a touch panel including a coordinate input device 100 disposed therein is mounted as viewed from the touch panel side (front side);

FIG. 6 is a perspective view showing an example of a mobile terminal 101 in which a touch panel including a coordinate input device 100 disposed therein is mounted as viewed from the side (rear side) opposite to the touch panel side (front side);

FIG. 7 shows an example in which a user of a mobile terminal 101 holds the mobile terminal 101;

FIG. 8 is a circuit configuration diagram showing an outline of position detection in a capacitive touch panel 103;

FIG. 9 is a circuit configuration diagram showing an outline of position detection in a coordinate input device 100;

FIG. 10 shows intensities of reception signals for antenna lines X1 to X5;

FIG. 11 shows intensities of reception signals for antenna lines Y1 to Y5;

FIG. 12 is a graph showing the dependence of position detection on distance in a coordinate input device 100;

FIG. 13 shows intensities of reception signals for antenna lines X1 to X5 according to a second exemplary embodiment;

FIG. 14 shows intensities of reception signals for antenna lines X1 to X5 according to a third exemplary embodiment;

FIG. 15 schematically shows an electric field on a cross section of an antenna line X1 of a linear transmitting antenna unit;

FIG. 16 schematically shows an electric field on a cross section of a planer receiving antenna 3;

FIG. 17 schematically shows a configuration of a coordinate input device 500 according to a fifth exemplary embodiment;

FIG. 18 schematically shows a configuration of a signal generation unit 5 and a transmitting antennal unit 2;

FIG. 19 schematically shows the spread of an electromagnetic wave as an antenna line X1 is viewed in a cross-sectional direction;

FIG. 20 schematically shows a configuration of a coordinate input device 600 according to a sixth exemplary embodiment;

FIG. 21 is a perspective view showing an example of a mobile terminal 601 in which a touch panel including a coordinate input device 600 disposed therein is mounted as viewed from the touch panel side (front side);

FIG. 22 is a perspective view showing an example of a mobile terminal 601 in which a touch panel including a coordinate input device 600 disposed therein is mounted as viewed from the side (rear side) opposite to the touch panel side (front side);

FIG. 23 shows switching timings among receiving antennas 61 to 63;

FIG. 24 schematically shows a configuration of a coordinate input device 700 according to a seventh exemplary embodiment;

FIG. 25 is a perspective view showing an example of a mobile terminal 701 in which a touch panel including a coordinate input device 700 disposed therein is mounted as viewed from the touch panel side (front side);

FIG. 26 shows a correspondence relation between receiving antennas 71 and 72 and antenna lines;

FIG. 27 shows a correspondence relation between receiving antennas 73 and 74 and antenna lines;

FIG. 28 is a perspective view showing an example of a mobile terminal 707 in which a touch panel in which a modified example of the coordinate input device 700 is provided is mounted as viewed from the touch panel side (front side);

FIG. 29 shows intensities of reception signals for antenna lines X1 to X5 according to an eighth exemplary embodiment;

FIG. 30 shows intensities of reception signals for antenna lines Y1 to Y5 according to the eighth exemplary embodiment;

FIG. 31 schematically shows a configuration of a coordinate input device 900 according to a ninth exemplary embodiment;

FIG. 32 shows position detection in the coordinate input device 900 when the distance between a finger 10 and a transmitting antenna unit 2 is short;

FIG. 33 shows a flowchart showing operations of the coordinate input device 900;

FIG. 34 schematically shows a configuration of a coordinate input device 1000 according to a tenth exemplary embodiment;

FIG. 35 shows connection of the coordinate input device 1000 when the position of a finger 10 is detected by a capacitive type method;

FIG. 36 shows a connection of the coordinate input device 1000 when the position of a finger 10 is detected in a state where the finger 10 is not in contact with a transmitting antenna unit 2;

FIG. 37 shows a flowchart showing operations of the coordinate input device 1000;

FIG. 38 schematically shows a configuration of a coordinate input device 1100 according to an eleventh exemplary embodiment;

FIG. 39 schematically shows a configuration of a signal generation unit 7;

FIG. 40 schematically shows a configuration of a detection unit 8;

FIG. 41 shows a frequency spectrum of noises when frequencies of a carrier wave and an AC signal are changed;

FIG. 42 schematically shows position detection in a coordinate input device according to a twelfth exemplary embodiment;

FIG. 43 shows an example of a waveform of low frequency components extracted from a reception signal;

FIG. 44 is a configuration diagram showing an example of a common resistive film type touch panel 800; and

FIG. 45 is a configuration diagram showing an example of a common capacitive type touch panel 900.

### DETAILED DESCRIPTION

Exemplary embodiments according to the present invention are explained hereinafter with reference to the drawings. The same symbols are assigned to the same components/structures throughout the drawings, and duplicated explanations are omitted as appropriate.

### First Exemplary Embodiment

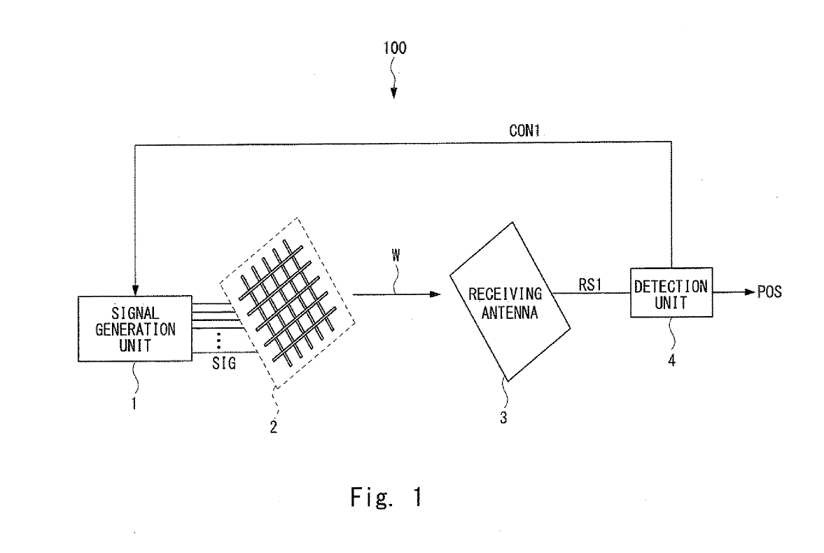

Firstly, a coordinate input device 100 according to a first exemplary embodiment is explained. FIG. 1 schematically shows a configuration of the coordinate input device 100 according to the first exemplary embodiment. The coordinate input device 100 includes a signal generation unit 1, a transmitting antenna unit 2, a receiving antenna 3, and a detection unit 4. The transmitting antenna unit 2 and the receiving antenna 3 are disposed spatially away from each other. Note that the transmitting antenna unit is also referred to as “first transmission/reception unit”. The receiving antenna is also referred to as “second transmission/reception unit”.

The signal generation unit 1 supplies an AC (Alternating Current) signal SIG to the transmitting antenna unit 2. The transmitting antenna unit 2 includes a plurality of antenna lines arranged in a mesh pattern, details of which are described later. The signal generation unit 1 supplies the AC signal SIG to one of the plurality of antenna lines of the transmitting antenna unit 2. As a result, an electromagnetic wave W (radio wave), which is a signal for transmitting the AC signal SIG, is emitted one of the plurality of antenna lines of the transmitting antenna unit 2. Note the antenna line is also simply referred to as “antenna”.

The receiving antenna 3 receives the signal emitted from the transmitting antenna unit 2. The receiving antenna 3 outputs the received signal to the detection unit 4 as a reception signal RS1. For the electromagnetic wave W, which is a signal for transmitting the AC signal SIG, an electromagnetic wave having a wavelength sufficiently longer than the size of the receiving antenna 3 is used. For example, the wavelength of the electromagnetic wave W is preferably at least ten times as large as the size of the transmitting antenna unit 2 and the receiving antenna 3. That is, an electromagnetic wave having a frequency lower than the resonance frequency of the receiving antenna 3 is used. For example, an electromagnetic wave having a frequency of about 1 to 10 MHz has a wavelength of 300 to 30 m. Therefore, common mobile terminals having sizes of about 10 inches are sufficiently small compared to the wavelengths of such electromagnetic waves. In such cases, the transmission of a signal by an electromagnetic wave is performed by the near field rather than the far field, which is used in the ordinary radio techniques. The signal intensity in communication by the near field changes more widely depending on the distance than in communication by the far field. Therefore, the determination of a distance can be made more easily in the communication by the near field.

The detection unit 4 outputs a control signal CON1 to the signal generation unit 1 and thereby controls the signal generation unit 1 as to which of the antenna lines of the transmitting antenna unit 2 the signal generation unit 1 should supply the AC signal SIG. Then, the detection unit 4 detects the intensity of the signal received by the receiving antenna 3 and associates each antenna line with the intensity of its reception signal. The detection unit 4 switches the antenna line to which the AC signal SIG is supplied at a predetermined time interval by using the control signal CON1 and thereby can detect the intensity of the reception signal for each antenna line of the transmitting antenna unit 2.

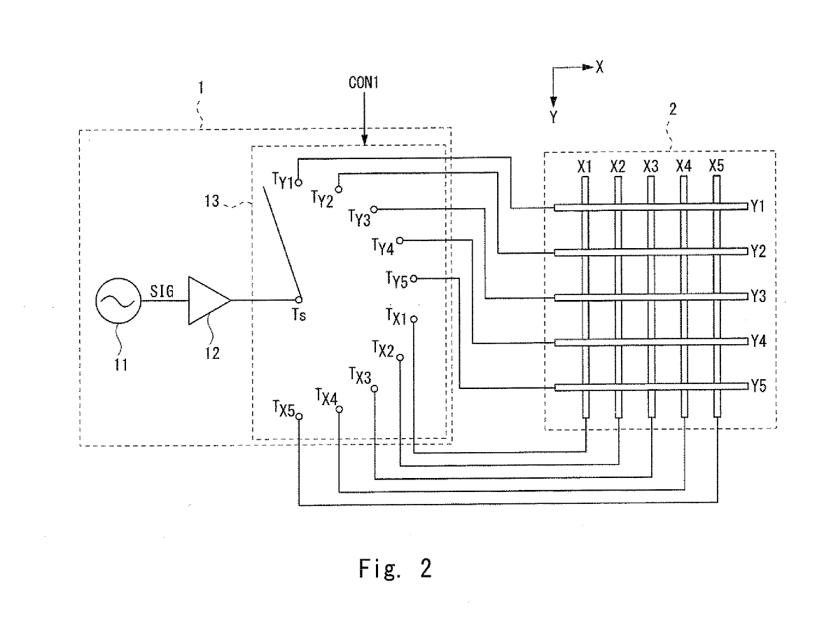

The signal generation unit 1 and the transmitting antenna unit 2 are explained hereinafter in detail. FIG. 2 schematically shows a configuration of the signal generation unit 1 and the transmitting antennal unit 2. The signal generation unit 1 includes a signal oscillation unit 11, an amplifier 12, and a multiplexer 13 (hereinafter expressed as “MUX 13”). The signal oscillation unit 11 oscillates an AC signal SIG and supplies the AC signal SIG to the amplifier 12. The amplifier 12 amplifies the AC signal SIG and the amplified AC signal SIG to the MUX 13.

The transmitting antenna unit 2 includes antenna lines X1 to X5 extending in the Y-direction and antenna lines Y1 to Y5 extending in the X-direction. In FIG. 2, the X- and Y-directions are orthogonal to each other. The antenna lines X1 to X5 are disposed below the antenna lines Y1 to Y5. Although an example in which the number of antenna lines in the X-direction and the number of antenna lines in the Y-direction are both five is shown in FIG. 2, this configuration is merely an example. An arbitrary number of antenna lines may be disposed in each of the X- and Y-directions. Further, the number of antenna lines in the X-direction may be the same as or different from the number of antenna lines in the Y-direction. Furthermore, the antenna lines in the Y-direction may be disposed below or above the antenna lines in the X-direction.

The MUX 13 includes terminals T_{X1} to T_{X5}, terminals T_{Y1} to T_{Y5}, and a terminal Tₛ. The terminal Tₛ is connected to the output terminal of the amplifier 12. The terminals T_{X1} to T_{X5} and T_{Y1} to T_{Y5} of the multiplexer are connected to the antenna lines X1 to X5 and Y1 to Y5, respectively. The MUX 13 connects the terminal Tₛ to one of the terminals T_{X}′ to T_{X5} and T_{Y1} to T_{Y5} according to the control signal CON1 received from the detection unit 4.

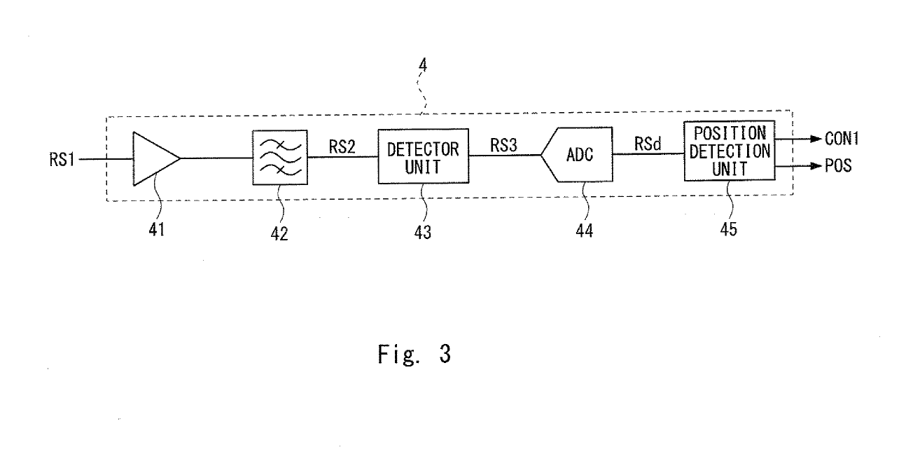

The detection unit 4 is explained in detail. FIG. 3 is a block diagram schematically showing a configuration of the detection unit 4. The detection unit 4 includes an amplifier 41, a filter 42, a detector unit 43, an A/D converter 44, and a position detection unit 45. The amplifier 41 amplifies a reception signal RS1 received through the receiving antenna 3 and outputs the amplified signal to the filter 42. The filter 42 outputs a reception signal RS2 obtained by removing unnecessary frequency components such as noises from the reception signal RS1 to the detector unit 43. The detector unit 43 detects an amplitude, a frequency shift, a phase shi, and so on of a specific frequency component(s) of the AC signal of the reception signal RS2, and outputs a voltage corresponding to these detected parameters to the A/D converter 44. The A/D converter 44 converts an analog reception signal RS3 to a digital signal and outputs the digital reception signal RSd to the position detection unit 45. In this way, the intensity of the reception signal is converted into a numerical value. Therefore, the intensity of the reception signal can be quantitatively evaluated by the position detection unit 45. In other words, the intensity of the electromagnetic wave W received through the receiving antenna 3 can be detected by converting the electromagnetic wave W into a reception signal such as a voltage signal and a current signal. The position detection unit 45 selects an antenna line through which the electromagnetic wave W is transmitted by using the control signal CON1, and can detect the intensity of the reception signal in that state and associate the intensity with the selected antenna line. Position information POS detected by the position detection unit 45 is output as desired to an external computer or the like.

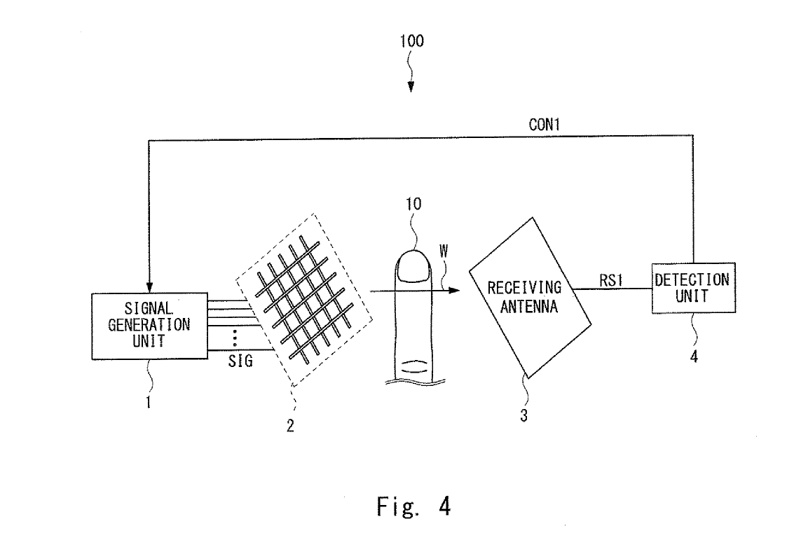

In the coordinate input device 100, an AC signal SIG is wirelessly transmitted between the transmitting antenna unit 2 and the receiving antenna 3 by using the electromagnetic wave W. In this process, if a conductor is inserted between the transmitting antenna unit 2 and the receiving antenna 3, the intensity of the signal received by the receiving antenna 3 changes. FIG. 4 schematically shows a configuration of the coordinate input device 100 in which an electric conductor is inserted between the transmitting antennal unit 2 and the receiving antenna 3. In particular, FIG. 4 shows an example in which a finger 10 of a user of the coordinate input device 100 is inserted as an example of the conductor. When the finger 10 is inserted between the transmitting antenna unit 2 and the receiving antenna 3, the intensity of the signal changes from the intensity at the time when the finger 10 is not inserted. Therefore, it is possible to detect the presence/absence of the finger 10 located between the transmitting antenna unit 2 and the receiving antenna 3 by detecting a change in the signal intensity by using the detection unit 4. In this way, the detection unit 4 can detect the position of the finger 10 with respective to the transmitting antenna unit 2.

In FIGS. 1 and 4, the transmitting antenna unit 2 and the receiving antenna 3 are explained. It should be noted that the transmitting antenna 2 can be used as a receiving antenna and the receiving antenna 3 can be used as a transmitting antenna. In this case, instead of the signal oscillation unit 11 and the amplifier 12, the detection unit 4 shown in FIG. 3 is connected to the terminal TS shown in FIG. 2. Further, the signal oscillation unit 11 and the amplifier 12 are connected to the receiving antenna 3. Further, the antenna lines are composed of two sets of orthogonal antenna lines, i.e., the antenna lines in the X- and Y-directions orthogonal to each other. However, this configuration is merely an example. For example, a set of antenna lines in a different direction such as a set of antenna lines in the Z-direction orthogonal to the X- and Y-directions may be disposed.

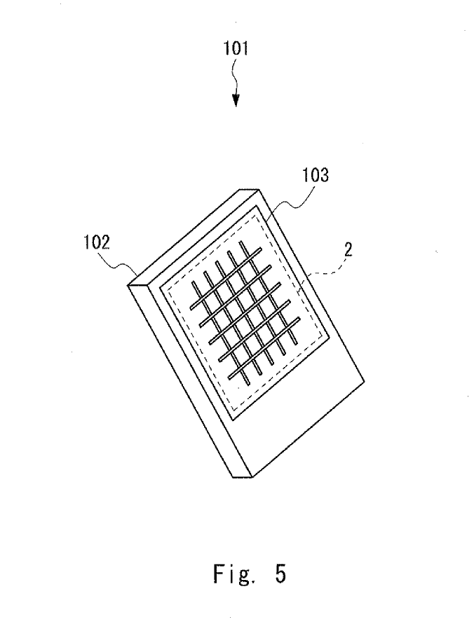

Next, an embodiment showing how the coordinate input device 100 is implemented is explained. FIG. 5 is a perspective view showing an example of a mobile terminal 101 in which a touch panel including the coordinate input device 100 disposed therein is mounted as viewed from the touch panel side (front side). For example, the mobile terminal 101 is a smartphone. A touch panel 103 is mounted on the front side of a housing 102 of the mobile terminal 101. The transmitting antenna unit 2 is incorporated into the touch panel 103. A plurality of antenna lines in a mesh pattern disposed in the transmitting antenna unit 2 function as transmitting antennas of the coordinate input device 100 and also function as electrodes of the capacitive touch panel 103.

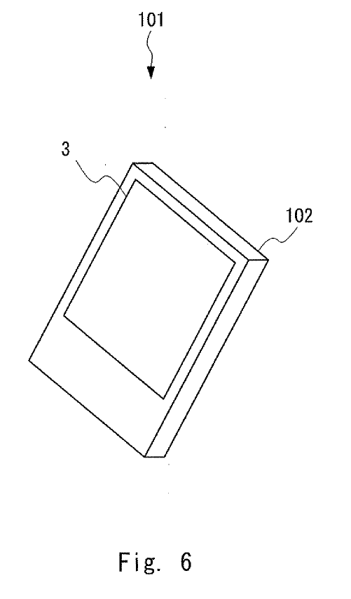

FIG. 6 is a perspective view showing an example of a mobile terminal 101 in which a touch panel including the coordinate input device 100 disposed therein is mounted as viewed from the side (rear side) opposite to the touch panel side (front side). The receiving antenna 3 is mounted on the rear side of a housing 102 of the mobile terminal 101. The receiving antenna 3 may be disposed outside of the housing 102 or inside of the housing 102. That is, fingers may come into contact with the receiving antenna 3 or may not come into contact with the receiving antenna 3. Similarly to this example, fingers may or may not come into contact with the receiving antenna in the other examples shown below. The signal generation unit 1 and the detection unit 4 are disposed inside the housing 102 of the mobile terminal 101.

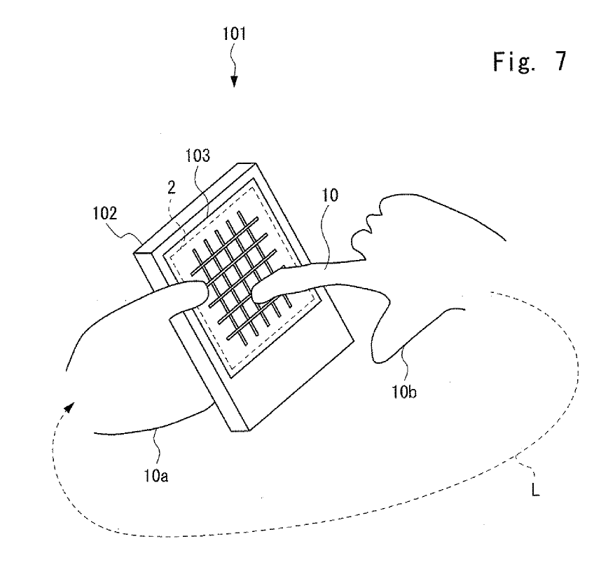

When the coordinate input device 100 is incorporated into the mobile terminal 101 as described above, a user of the mobile terminal 101 operates the mobile terminal 101 by touching the touch panel 103 with his/her fingers. FIG. 7 shows an example in which a user of the mobile terminal 101 holds the mobile terminal 101. As shown in FIG. 7, the user holds the mobile terminal 101 with, for example, his left hand 10a. In this state, some of the fingers of the left hand 10a are in contact with the rear side (receiving antenna 3 side) of the mobile terminal 101. Further, the user moves some of the fingers of the left hand 10a or a finger(s) 10 of his right hand 10b above the touch panel in order to operate the mobile terminal 101. When the user moves some of the fingers of the left hand 10a, an electromagnetic wave W is transmitted from the finger(s) located above the touch panel 103 through the finger(s) on the receiving antenna 3 side. When the user move the finger 10, an electromagnetic wave W is transmitted from the finger 10 through the human body (path L in FIG. 7) and the finger(s) of the left hand 10a.

Note that for the coordinate input device 100, a finger of the user functions as a king of an electric conductor. Therefore, the coordinate input device 100 can detect the position(s) of the finger(s) with respect to the transmitting antenna unit 2 as the coordinate input device 100 functions irrespective of whether the finger(s) of the user is in contact with the touch panel 103 or not. The principle based on which the coordinate input device 100 detects a finger(s) when the finger(s) is not in contact with the touch panel 103 is described later.

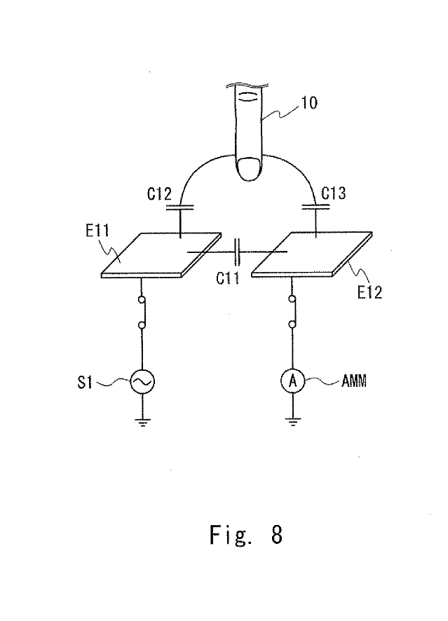

Next, differences between position detection by a capacitive touch panel and that by the coordinate input device 100 are explained. Firstly, a position detection method performed by a capacitive touch panel is explained. FIG. 8 is a circuit configuration diagram showing an outline of the position detection in the capacitive touch panel 103. In FIG. 8, the touch panel 103 includes electrodes E11 and E12, a signal generation unit 1, and an ammeter AMM. The electrode E11 corresponds to one of the antenna lines X1 to X5 of the transmitting antenna unit 2. The electrode E12 corresponds to one of the antenna lines Y1 to Y5 of the transmitting antenna unit 2.

A signal from an oscillator S1 is supplied to the electrode E11. The ammeter AMM is connected to the electrode E12. A capacitance C11 occurs between the electrodes E11 and E12. When a finger 10 comes close to the electrodes E11 and E12 in a state where the signal is being supplied from the oscillator S1 to the electrode E11, a capacitance C12 occurs between the electrode E11 and the finger and a capacitance C13 occurs between the electrode E12 and the finger.

A combined capacitance Cₜ₁ of the capacitances C11, C12 and C13 is expressed by Expression (1) shown below.

$$\begin{matrix}[ Expression 1 ] & \\ {C}_{t 1} = C 11 + \frac{1}{\frac{1}{C 12} + \frac{1}{C 13}} = \frac{C 11 C 12 + C 11 C 13 + C 12 C 13}{C 12 + C 13} & ( 1 )\end{matrix}$$

When the finger 10 is moved away from the Electrodes E11 and E12, the capacitances C12 and C13 decrease compared to the capacitance C11. Therefore, the sensitivity of the capacitance detection to the change of the position of the finger 10 deteriorates. That is, the capacitive type cannot detect the position of the finger 10 when the finger 10 is moved away from the Electrodes E11 and E12. Therefore, it is necessary that the finger(s) is in contact with the touch panel in most of the capacitive touch panels. To improve the sensitivity in the state where the finger is moved away from the capacitive touch panel, the capacitance C11 needs to be reduced by increasing the distance between the Electrodes E11 and E12. However, in such a configuration, since the distance between the Electrodes E11 and E12 increases, the resolving power of the position detection deteriorates.

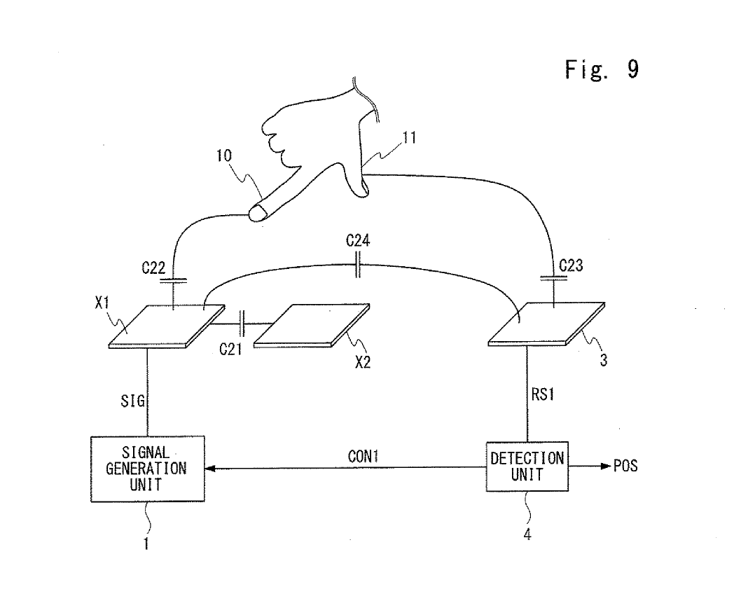

Next, position detection performed by the coordinate input device 100 is explained. FIG. 9 is a circuit configuration diagram showing an outline of the position detection in the coordinate input device 100. For simplifying the illustration, only the antenna lines X1 and X2 of the antenna lines of the transmitting antenna unit 2 are shown in FIG. 9. An AC signal SIG is selectively supplied from the signal generation unit 1 to each of the antenna lines X1 and X2. In this example, for simplifying the explanation, a case where the AC signal SIG is supplied to the antenna line X1 is explained. However, the antenna lines to which the AC signal SIG is supplied are not limited to the antenna line X1. A capacitance C21 occurs between the antenna lines X1 and X2. When fingers 10 and 11 are inserted between the antenna line X1 and the receiving antenna 3 in a state where a signal is being supplied from the signal generation unit 1 to the antenna line X1, a capacitance C22 occurs between the antenna line X1 and the finger 10 and a capacitance C23 occurs between the finger 10 and the receiving antenna 3. Further, a capacitance C24 exists between the antenna line X1 and the receiving antenna 3. Note that the fingers 10 and 11 may be different fingers or the one same finger, provided that they are electrically connected. Assume that the finger 10 is located near the antenna line X1 and the finger 11 is located near the receiving antenna 3.

In this position detection method, a signal is sent from the transmitting antenna unit 2 to the receiving antenna 3 through the fingers 10 and 11. In this method, signal transmission using an electromagnetic wave is performed in a distance that is sufficiently shorter than the wavelength of the electromagnetic wave (i.e., distance between the transmitting antenna unit 2 and the receiving antenna 3). Therefore, the signal transmission by the electric field is more dominant than the signal transmission by the electromagnetic wave. Therefore, the interactions among the antenna line X1, the fingers 10 and 11, and the receiving antenna 3 are expressed by capacitances. Since no AC signal is supplied from the signal generation unit 1 to the antenna line X2, the capacitance between the antenna lines X1 and X2 has no effect.

When the input impedance of the detection unit 4 is represented by Zᵢₙ and the frequency of the electromagnetic wave is represented by f, the ratio between the amplitude Vₜₓ of the transmission signal at the antenna line X1 and the amplitude Vᵣₓ of the reception signal at the receiving antenna 3 is expressed by Expression (2) shown below. Note that since the finger 10 is located near the antenna line X1 and the finger 11 is located near the receiving antenna 3, relations “C24<<C22” and “C24<<C23” are satisfied. Therefore, the capacitance C24 is negligible.

$$\begin{matrix}[ Expression 2 ] & \\ \frac{{V}_{rx}}{{V}_{tx}} = \frac{{Z}_{in}}{{Z}_{in} + \frac{1}{2 π f} ( \frac{1}{C 22} + \frac{1}{C 23} )} & ( 2 )\end{matrix}$$

As shown in Expression (2), the ratio (Vᵣₓ/Vₜₓ) between the amplitude of the transmission signal and the amplitude of the reception signal does not depend on the capacitance C21. Further, by setting the input impedance Zᵢₙ to a value close to 1/(2πfC22) and 1/(2πfC23), the ratio (Vᵣₓ/Vₜₓ) between the amplitude of the reception signal and the amplitude of the transmission signal can be increased.

As shown in Expression (2), since the detection unit 4 detects the amplitude of the AC signal rather than the capacitance, the detection unit 4 can extract a signal having a specific frequency by using, for example, a filter circuit or the like (filter 42 in FIG. 3). This makes it possible to improve the tolerance to noises Further, since the detection does not depend on the capacitance C21, the detection sensitivity does not deteriorate even when the distance between the antenna lines X1 and X2 is reduced, thus making it possible to improve the resolving power of the position detection.

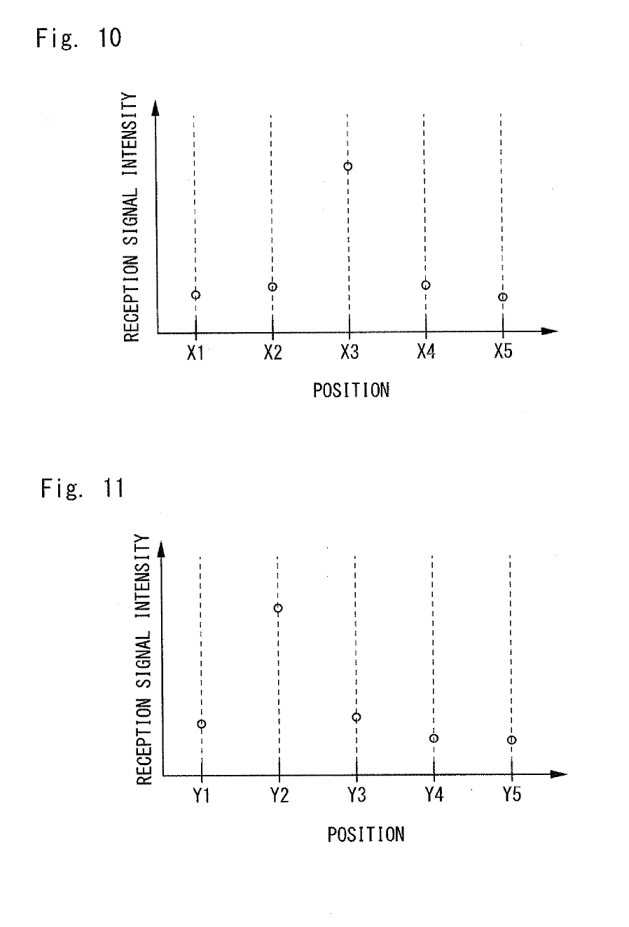

The detection unit 4 detects the intensity of the reception signal for each of the antenna lines X1 to X5 in a state where, for example, the finger 10 is at a standstill in a position away from the transmitting antenna unit 2. In this way, a distribution showing the dependence of the intensity of the reception signal on the position in the X-direction is obtained. Further, the detection unit 4 detects the intensity of the reception signal for each of the antenna lines Y1 to Y5. In this way, a distribution showing the dependence of the intensity of the reception signal on the position in the Y-direction is obtained. Therefore, it can be understood that a distribution of reception signal intensities on the XY-plane can be obtained. FIG. 10 shows intensities of reception signals for the antenna lines X1 to X5. FIG. 11 shows intensities of reception signals for the antenna lines Y1 to Y5. In this example, the intensity of the reception signal that is received through the antenna line X3 is the largest in the X-direction. Further, the intensity of the reception signal that is received through the antenna line Y2 is the largest in the Y-direction. In this way, it is possible to detect that the finger 10 exists at or near the intersection of the antenna lines X3 and Y2 in this example.

Therefore, it can be understood that by specifying the antenna line whose reception signal is the largest for each of the X- and Y-directions, the position of the finger (conductor) with respect to the transmitting antenna unit 2 can be detected.

Next, the dependence of position detection on distance in the coordinate input device 100 is explained. As described above, the transmission of a signal by an electromagnetic wave is performed by the near field rather than the far field, which is used in the ordinary radio techniques, in the coordinate input device 100. The signal intensity in communication by the near field changes more widely depending on the distance than in communication by the far field. Therefore, the determination of a distance can be made more easily in the communication by the near field.

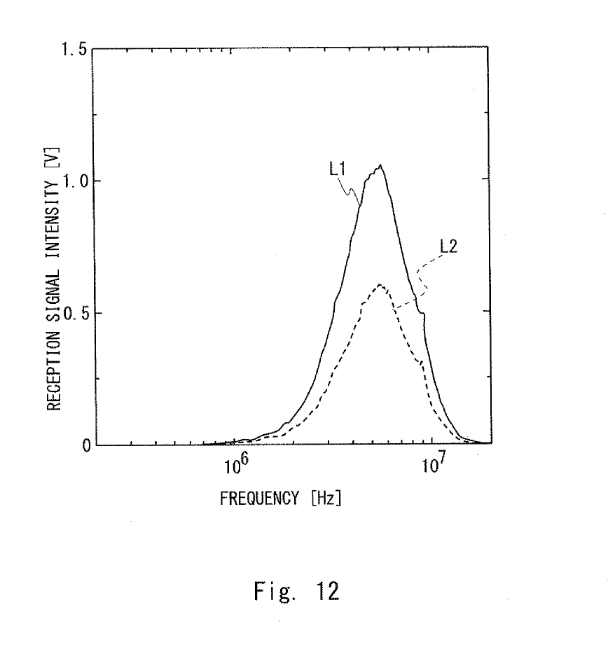

FIG. 12 is a graph showing the dependence of position detection on distance in the coordinate input device 100. In FIG. 12, the horizontal axis indicates frequencies and vertical axis indicates intensities (voltages) of reception signals detected by the detection unit 4. In FIG. 12, reception signal intensities in a state where the finger is in contact with the touch panel 103 is represented by a line L1 (solid line) and reception signal intensities in a state where the finger is located about 5 mm away from the touch panel 103 is represented by a line L2 (broken line).

As shown in FIG. 12, the intensity of the reception signal becomes weaker with the increase in the distance from the touch panel 103 to the finger. Therefore, the detection unit 4 can detect how much distance the detected finger is away from the touch panel 103 by measuring the intensity of the peak of the reception signal.

Note that although a case where the position of only one point is detected is explained in the above explanation, this case is merely an example. For example, needless to say, the positions of a plurality of fingers can be detected by detecting the second highest peak of the reception signal, the third highest peak of the reception signal, and so on.

In this configuration, an electromagnetic wave is transmitted between the first transmission/reception unit and the second transmission/reception unit. Then, the peak position of the signal intensity is detected by associating changes of the intensity of the reception signal caused by an electric conductor inserted between the first and second transmission/reception units with the positions of the plurality of antennas disposed in the first or second transmission/reception unit. In this way, the two-dimensional position of the electric conductor in the plane in which the first or second transmission/reception unit is disposed can be determined. Further, by evaluating the signal intensity, the distance from the plane in which the first or second transmission/reception unit is disposed to the electric conductor can be detected. Therefore, according to this configuration, the three-dimensional position of the electric conductor, which is inserted between the first and second transmission/reception units, can also be determined.

As a result, in this configuration, it is possible to detect the position of an electric conductor irrespective of whether the electric conductor is in contact with the first and second transmission/reception units or not. Consequently, it is possible to solve the problem that the position of a finger cannot be detected when the finger is not in contact with the touch panel, which occurs in capacitive touch panels.

Note that above explanation is given on the assumption that a signal is transmitted from the first transmission/reception unit and received by the second transmission/reception unit. However, a signal may be transmitted from the second transmission/reception unit and received by the first transmission/reception unit. In this case, the signal generation unit 1 is connected to the second transmission/reception unit and the detection unit 4 is connected to the first transmission/reception unit.

### Second Exemplary Embodiment

Next, a coordinate input device according to a second exemplary embodiment is explained. In this exemplary embodiment, a modified example of the position detection method performed in the position detection unit 45 of the detection unit 4 of the coordinate input device 100 is explained.

In the first exemplary embodiment, a method for detecting the position of a finger in which the position detection unit 45 specifies an antenna line whose reception signal intensity is the largest for each of the X- and Y-directions to detect the position of the finger is explained. However, the resolving power of the position detection is limited to the array pitch of the antenna lines in this method. In this exemplary embodiment, a method for improving the resolving power of the position detection without reducing the array pitch of the antenna lines is explained.

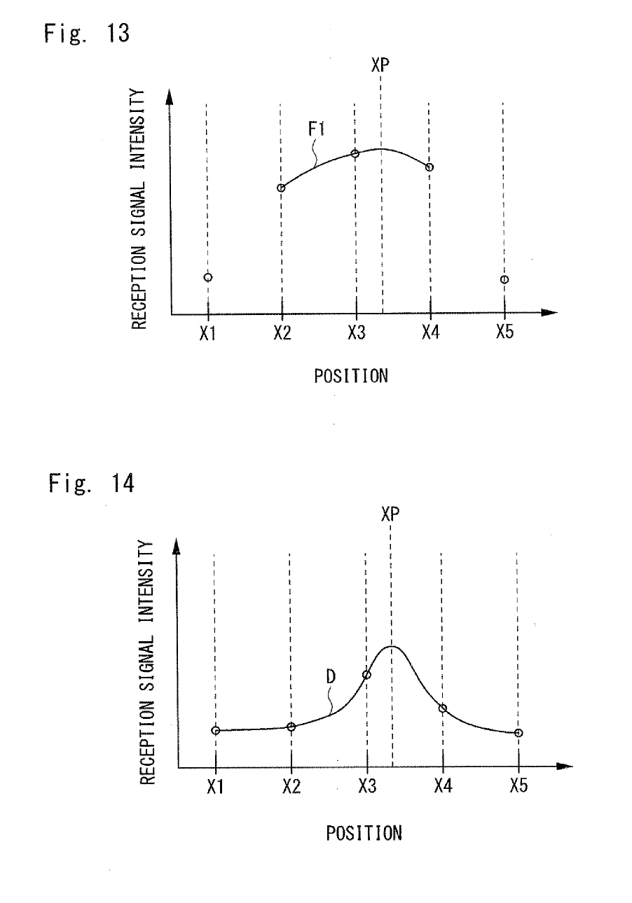

FIG. 13 shows intensities of reception signals for the antenna lines X1 to X5 according to a second exemplary embodiment. As shown in FIG. 13, the position detection unit 45 generates a polynomial expression F1 that is the closest approximate expression approximating data of intensities of the reception signals of the antenna lines X1 to X5. Then, the position detection unit 45 detects an X-coordinate XP at the peak of the polynomial expression F1. Similarly, the position detection unit 45 generates a similar polynomial expression for intensities of the reception signals of the antenna lines Y1 to Y5 and detects a Y-coordinate YP at the peak of that polynomial expression. In this way, the position detection unit 45 can detect the coordinates (XP, YP) as the position of the finger.

In this exemplary embodiment, it is possible to make the resolving power of the position detection smaller than the array pitch of the antenna lines by performing interpolation between adjacent antenna lines by using a polynomial expression. As a result, it is possible to realize a coordinate input device having better resolving power for position detection than that of the first exemplary embodiment.

### Third Exemplary Embodiment

Next, a coordinate input device according to a third exemplary embodiment is explained. In this exemplary embodiment, a modified example of the position detection method performed in the position detection unit 45 of the detection unit 4 of the coordinate input device 100 is explained.

In the first exemplary embodiment, a method for detecting the position of a finger in which the position detection unit 45 specifies an antenna line whose reception signal intensity is the largest for each of the X- and Y-directions to detect the position of the finger is explained. However, the resolving power of the position detection is limited to the array pitch of the antenna lines in this method. In this exemplary embodiment, a method for improving the resolving power of the position detection without reducing the array pitch of the antenna lines is explained.

FIG. 14 shows intensities of reception signals for the antenna lines X1 to X5 according to a third exemplary embodiment. The position detection unit 45 stores a predicted distribution of reception signals in advance, and detects the position of a finger by comparing measured data with this distribution. As shown in FIG. 14, the position detection unit 45 applies a predicted distribution D to data of intensities of reception signals of the antenna lines X1 to X5 Note that the predicted distribution D is applied so that the correlation between the data of intensities of reception signals of the antenna lines X1 to X5 and the predicted distribution D is maximized. Then, the position detection unit 45 detects an X-coordinate XP at the peak of the predicted distribution D. Similarly, the position detection unit 45 applies a predicted distribution to data of intensities of reception signals of the antenna lines Y1 to Y5 and detects a Y-coordinate YP at the peak of that predicted distribution. Note that the the predicted distribution is applied so that the correlation between the data of intensities of reception signals of the antenna lines Y1 to Y5 and the predicted distribution is maximized. In this way, the position detection unit 45 can detect the coordinates (XP, YP) as the position of the finger.

In this exemplary embodiment, it is possible to make the resolving power of the position detection smaller than the array pitch of the antenna lines by applying a predicted distribution to the reception signal intensities of the antennal lines. As a result, it is possible to realize a coordinate input device having better resolving power for position detection than that of the first exemplary embodiment.

### Fourth Exemplary Embodiment

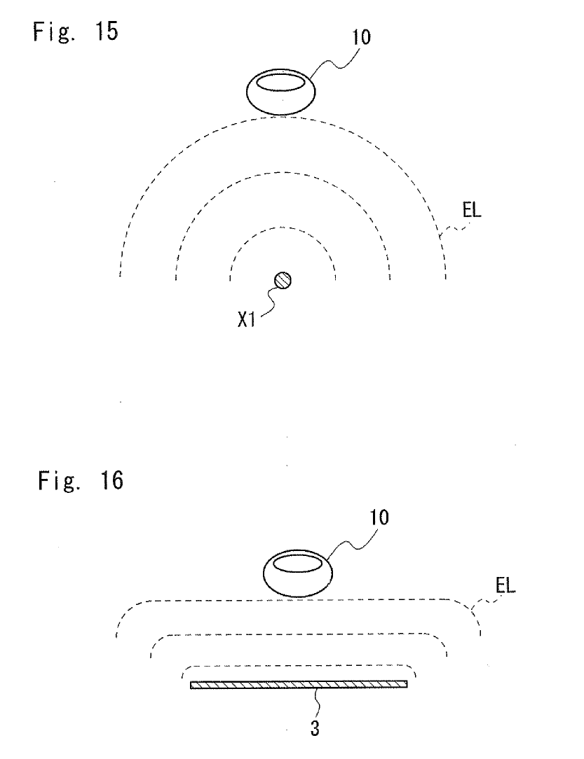

Next, a coordinate input device according to a fourth exemplary embodiment is explained. In this exemplary embodiment, effects of the shapes of the antenna lines of the transmitting antenna unit 2 and the receiving antenna 3 are explained. FIG. 15 schematically shows an electric field on a cross section of a linear antenna line X1 of the transmitting antenna unit 2. Note that the antenna line X1 is just a representative example. That is, the antenna lines X2 to X5 and Y1 to Y5 also form similar electric fields. FIG. 16 schematically shows an electric field on a cross section of a planer receiving antenna 3. In each of FIGS. 15 and 16, isoelectric lines ELs are illustrated. The receiving antenna 3 has a planar shape. Therefore, when a finger 10 exists near the receiving antenna 3, the intensity of the transmitted signal changes in inverse proportion to the distance. In contrast to this, the antenna line X1 has a linear shape. Therefore, when a finger 10 exists near the receiving antenna, the intensity of the transmitted signal changes in inverse proportion to the square of the distance. That is, the signal intensity of the linear antenna line X1 has a large dependence on the distance, while the signal intensity of the planar receiving antenna 3 has a small dependence on the distance.

That is, by using linear antenna lines for the transmitting antenna unit 2 and using a planar antenna for the receiving antenna 3, the dependence of the signal intensity on the distance between the receiving antenna 3 and the human body can be reduced. As a result, it is possible to detect the distance between the antenna line of the transmitting antenna unit 2 and the finger 10 with high accuracy.

### Fifth Exemplary Embodiment

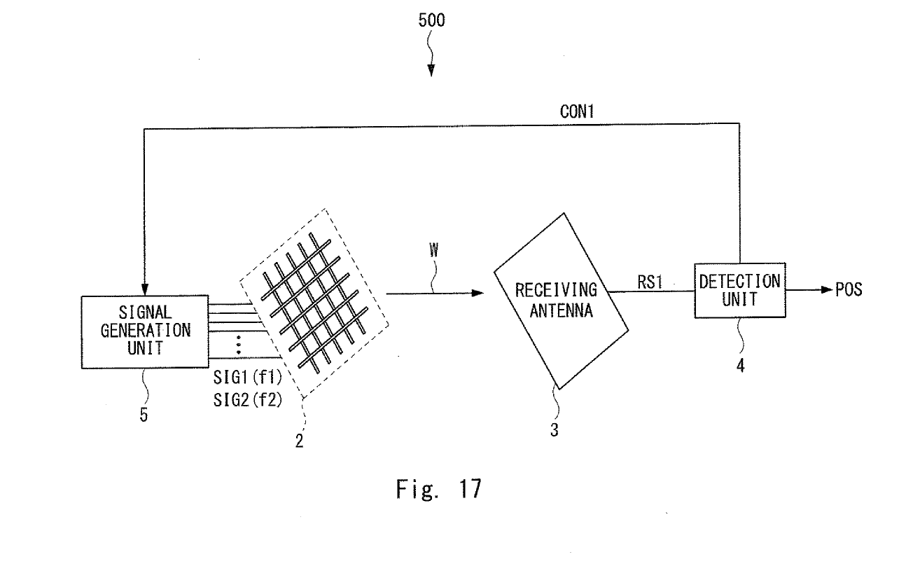

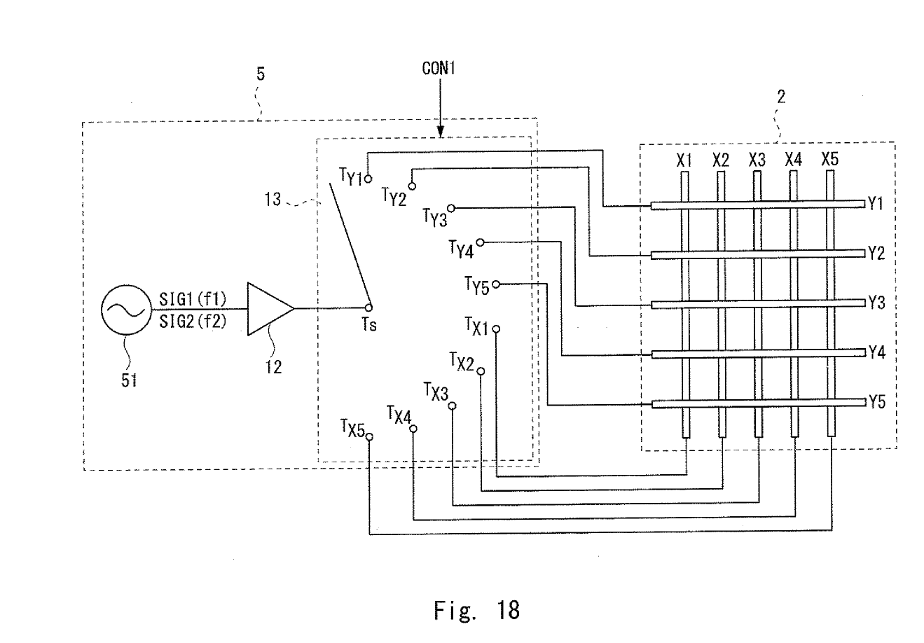

Next, a coordinate input device 500 according to a fifth exemplary embodiment is explained. The coordinate input device 500 is a modified example of the coordinate input device 100 according to the first exemplary embodiment. FIG. 17 schematically shows a configuration of the coordinate input device 500 according to the fifth exemplary embodiment. The coordinate input device 500 is obtained by replacing the signal generation unit 1 with a signal generation unit 5 in the coordinate input device 100. The other configuration of the coordinate input device 500 is similar to that of the coordinate input device 100.

FIG. 18 schematically shows a configuration of the signal generation unit 5 and the transmitting antennal unit 2. The signal generation unit 5 is obtained by replacing the signal oscillation unit 11 of the signal generation unit 1 with a signal oscillation unit 51. The signal oscillation unit 51 outputs an AC signal having a different frequency according to the control signal CON1 received from the detection unit 4. In this example, a case where the signal oscillation unit 51 outputs an AC signal SIG1 having a frequency f1 or an AC signal SIG2 having a frequency f2 is shown. For simplifying the figure, the illustration of the internal configuration of the MUX 13 is omitted in FIG. 18. For example, the frequency f1 may be set to 1 MHz to 10 MHz, and the frequency f3 may be set to 10 KHz to 1 MHz. Note that the number of frequencies of signals output by the signal oscillation unit is not limited to two. That is, the signal oscillation unit may output three or more signals having different frequencies.

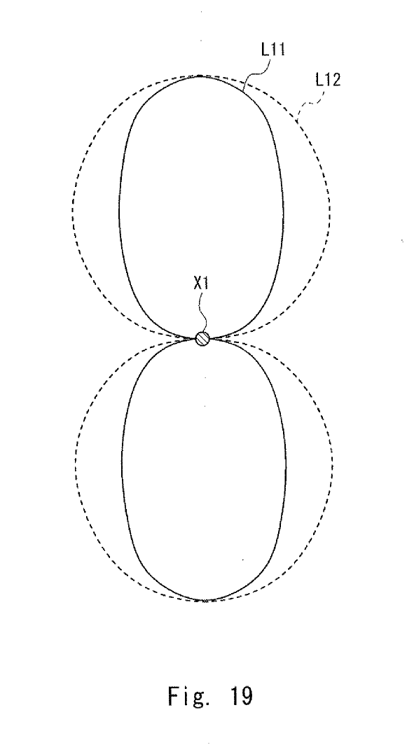

In general, the higher the frequency of the electromagnetic wave is, the stronger directivity the antenna has. FIG. 19 schematically shows the spread of an electromagnetic wave as the antenna line X1 is viewed in a cross-sectional direction. In FIG. 19, the spread of an electric field when the frequency of the electromagnetic wave is high is represented by solid lines L11, and the spread of an electric field when the frequency of the electromagnetic wave is low is represented by broken lines L12. Note that the antenna line X1 is just a representative example. That is, the antenna lines X2 to X5 and Y1 to Y5 also form electric fields similar to that of the antenna line X1. When a signal having a low frequency is used, the dependence of the obtained signal intensity on the position of the finger decreases. Therefore, the differences of signal intensities among the antennas decrease. On the other hand, when a signal having a high frequency is used, the dependence of the obtained signal intensity on the position of the finger increases. Therefore, the differences of signal intensities among the antennas increase.

By using the effect that is obtained by using electromagnetic waves having different frequencies, the below-described position detection can be realized. Firstly, the distance between a finger and the transmitting antenna unit 2 is estimated by measuring the intensity of a signal having a low frequency. Since the directivity of the antenna is weak when a signal having a low frequency is used, the dependence on the position in the direction parallel to the main surface of the transmitting antenna unit 2 becomes smaller. As a result, the measurement accuracy of the distance in the direction perpendicular to the main surface of the transmitting antenna unit 2 improves.

Next, when a signal having a high frequency is used, the directivity of the antenna becomes stronger. Therefore, the differences of signal intensities among the antennas increase. Accordingly, the dependence on the position in the direction parallel to the main surface of the transmitting antenna unit 2 becomes larger. As a result, the measurement accuracy of the distance in the direction parallel to the main surface of the transmitting antenna unit 2 improves.

Therefore, it is possible to improve both the distance measurement accuracy in the direction perpendicular to the main surface of the transmitting antenna unit 2 and the finger position detection accuracy in the direction parallel to the main surface of the transmitting antenna unit 2 by temporally changing the frequency of the AC signal.

### Sixth Exemplary Embodiment

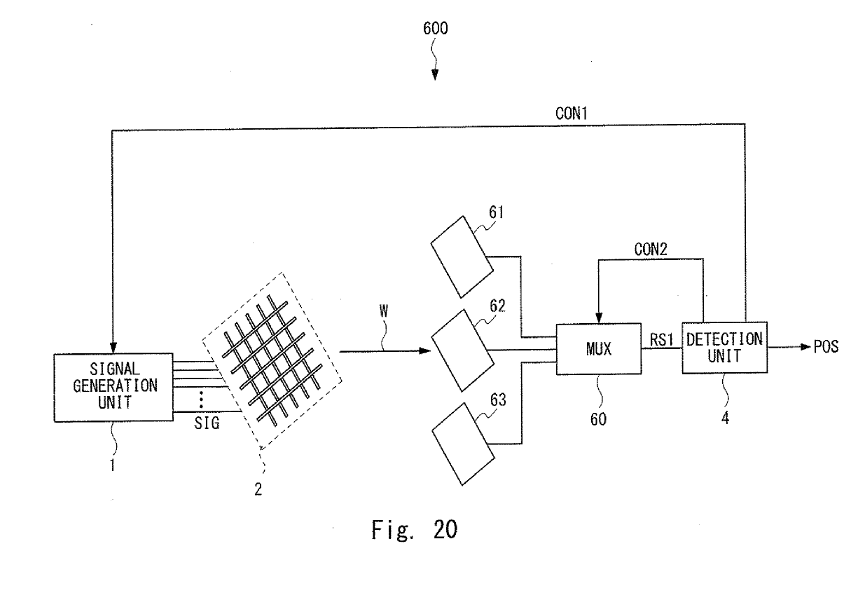

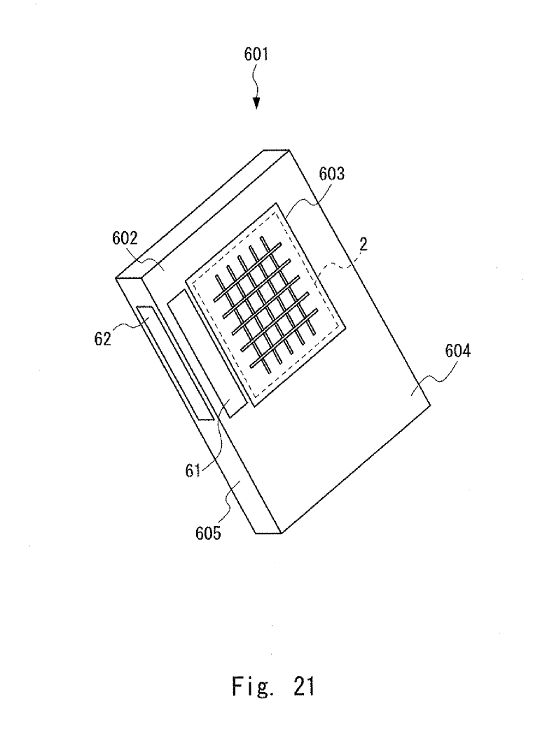

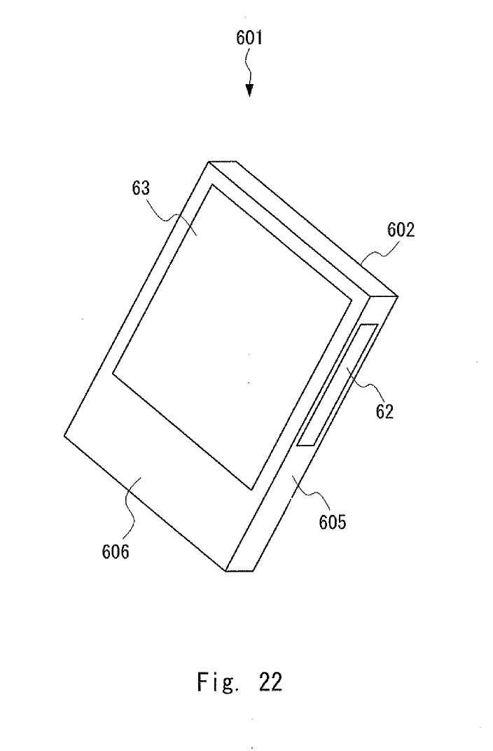

Next, a coordinate input device 600 according to a sixth exemplary embodiment is explained. The coordinate input device 600 is a modified example of the coordinate input device 100 according to the first exemplary embodiment. FIG. 20 schematically shows a configuration of the coordinate input device 600 according to the sixth exemplary embodiment. The coordinate input device 600 includes a plurality of receiving antennas. FIG. 20 shows an example in which the coordinate input device 600 includes receiving antennas 61 to 63. Further, one of the receiving antennas 61 to 63 is selected by a multiplexer (MUX) 60 and connected to the detection unit 4. Note that the detection unit 4 can perform control according to a control signal CON2 as to which of the receiving antennas 61 to 63 should be connected to the detection unit 4.

Next, an arrangement of the receiving antennas 61 to 63 is explained. FIG. 21 is a perspective view showing an example of a mobile terminal 601 in which a touch panel including the coordinate input device 600 disposed therein is mounted as viewed from the touch panel side (front side). In the mobile terminal 601, a touch panel 603 is provided on the front surface 604 of a housing 602. The transmitting antenna unit 2 is incorporated into the touch panel 603. In this example, the receiving antenna 61 is disposed in the outer peripheral section of the touch panel 603 on the front surface 604. The receiving antenna 62 is disposed on the side surface 605 of the mobile terminal 601.

FIG. 22 is a perspective view showing the example of the mobile terminal 601 in which the touch panel including the coordinate input device 600 disposed therein is mounted as viewed from the side (rear side) opposite to the touch panel side (front side). The receiving antenna 63 is disposed on the rear surface 606 of the mobile terminal 601.

The receiving antenna 63 disposed on the rear surface 606 can effectively receive an electromagnetic wave when a user holds the mobile terminal 601 with his/her hand. However, when the mobile terminal 601 is placed on a desk in a state where the rear surface 606 faces downward, the rear surface 606 is hidden. Therefore, the receiving antenna 63 can hardly receive an electromagnetic wave. However, since the receiving antenna 61 on the front surface 604 and the receiving antenna on the side surface 605 are exposed, they can easily receive an electromagnetic wave. As described above, the receiving antenna that has the optimal reception sensitivity changes depending on how the mobile terminal, into which the coordinate input device is incorporated, is used. Therefore, by disposing a plurality of receiving antennas indifference surfaces, it is possible to cope with the reception sensitivity changes resulting from the different ways of use of the mobile terminal, into which the coordinate input device is incorporated.

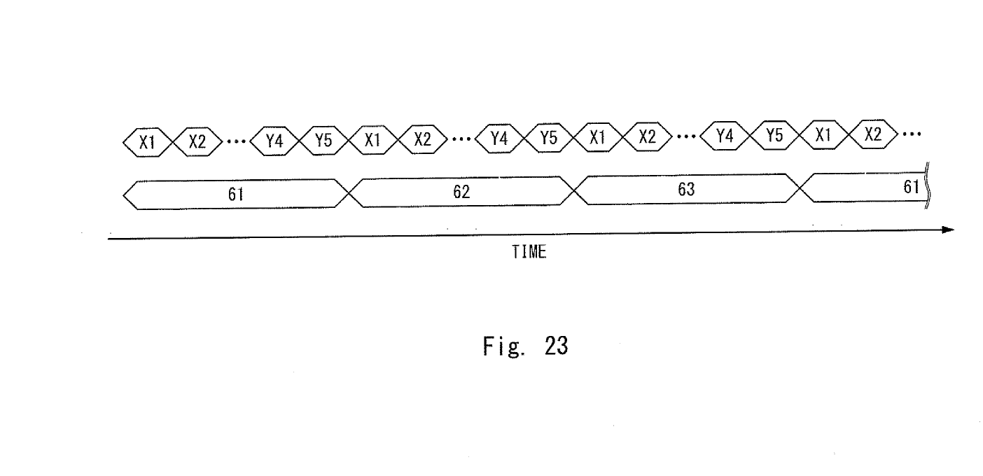

Further, the switching among the receiving antennas 61 to 63 can be performed in an orderly manner. FIG. 23 shows switching timings among the receiving antennas 61 to 63. The transmitting antenna unit 2 includes ten antenna lines. Therefore, the receiving antenna to be used may be switched every time reception intensities corresponding to the ten antenna lines are measured. Then, one of the receiving antennas 61 to 63 with which the reception intensity is optimized is determined. For example, one of the receiving antennas 61 to 63 with which the average reception intensity of all the antenna lines is the largest is determined. Then, the position detection of a finger may be performed by using the intensities of the signals received by the determined receiving antenna.

The above-described receiving antenna switching may be continuously performed. Alternatively, the receiving antenna switching may be stopped after the optimal receiving antenna is determined, and the determined receiving antenna may be continuously used.

Note that although a case where the number of the receiving antennas is three is explained in this exemplary embodiment, the number of the receiving antennas may be two or may be four or more.

### Seventh Exemplary Embodiment

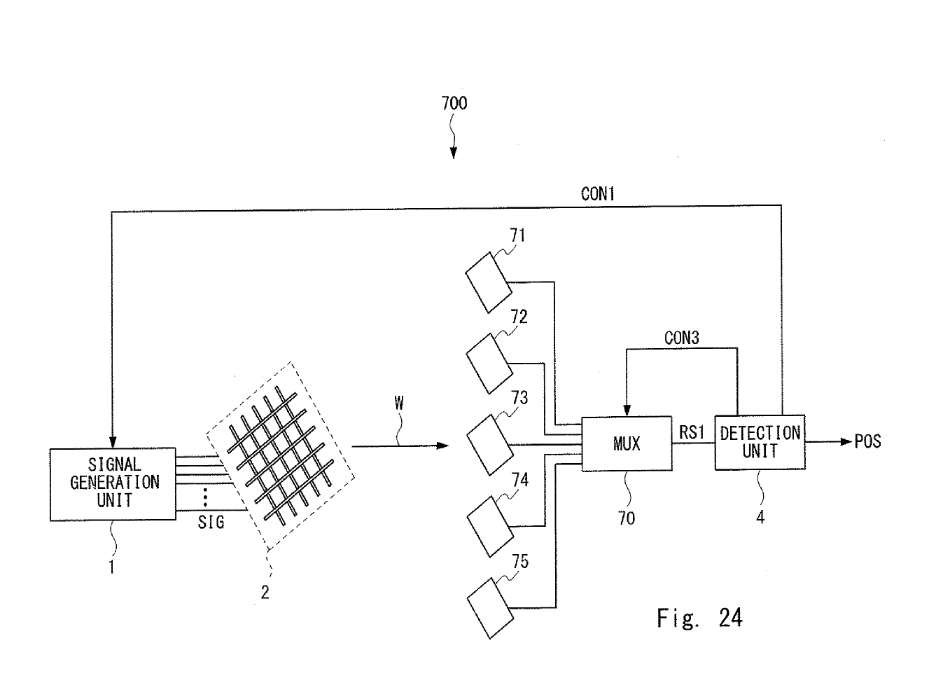

Next, a coordinate input device 700 according to a seventh exemplary embodiment is explained. The coordinate input device 700 is a modified example of the coordinate input device 600 according to the sixth exemplary embodiment. FIG. 24 schematically shows a configuration of the coordinate input device 700 according to the seventh exemplary embodiment. Similarly to the coordinate input device 600, the coordinate input device 700 includes a plurality of receiving antennas. FIG. 24 shows an example in which the coordinate input device 700 includes receiving antennas 71 to 75. One of the receiving antennas 71 to 75 is selected by a multiplexer (MUX) 70 and connected to the detection unit 4. Note that the detection unit 4 can perform control according to a control signal CON3 as to which of the receiving antennas 71 to 75 should be connected to the detection unit 4.

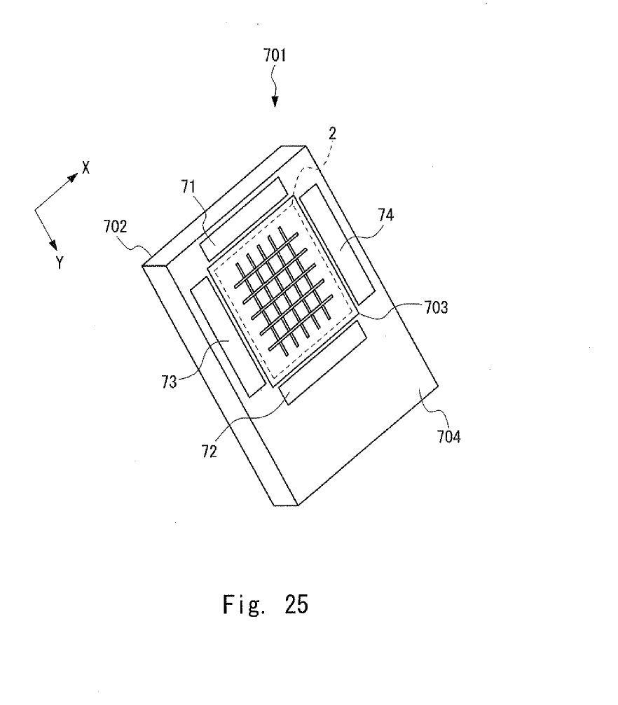

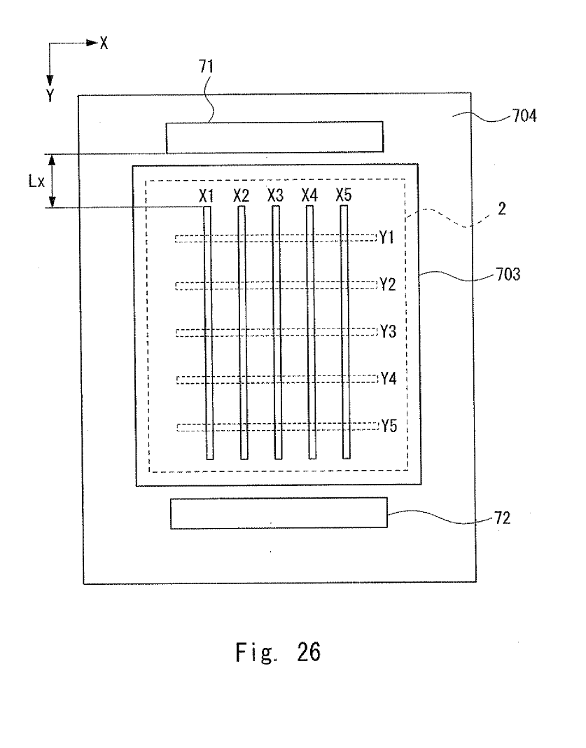

Next, an arrangement of the receiving antennas 71 to 75 is explained. FIG. 25 is a perspective view showing an example of a mobile terminal 701 in which a touch panel including the coordinate input device 700 disposed therein is mounted as viewed from the touch panel side (front side). In the mobile terminal 701, a touch panel 703 is provided on the front surface 704 of a housing 702. The transmitting antenna unit 2 is incorporated into the touch panel 703. In this example, the receiving antennas 71 to 74 are disposed in the outer peripheral section of the touch panel 703 on the front surface 704. Note that the receiving antenna 75 is disposed in a similar position to that of the receiving antenna 63, and therefore its detailed explanation is omitted.

As shown in FIG. 25, the touch panel 703 is disposed in the center of the front surface 704 of the mobile terminal 701. The receiving antennas 71 to 74 are disposed in the peripheral section of the touch panel 703 on the front surface 704. Each of the receiving antennas 71 and 72 is a belt-shaped antenna whose longitudinal direction coincides with the X-direction. FIG. 26 shows a correspondence relation between the receiving antennas 71 and 72 and the antenna lines. The receiving antennas 71 and 72 are used to receive an electromagnetic wave when the electromagnetic wave is emitted from the antenna lines X1 to X5 of the transmitting antenna unit 2.

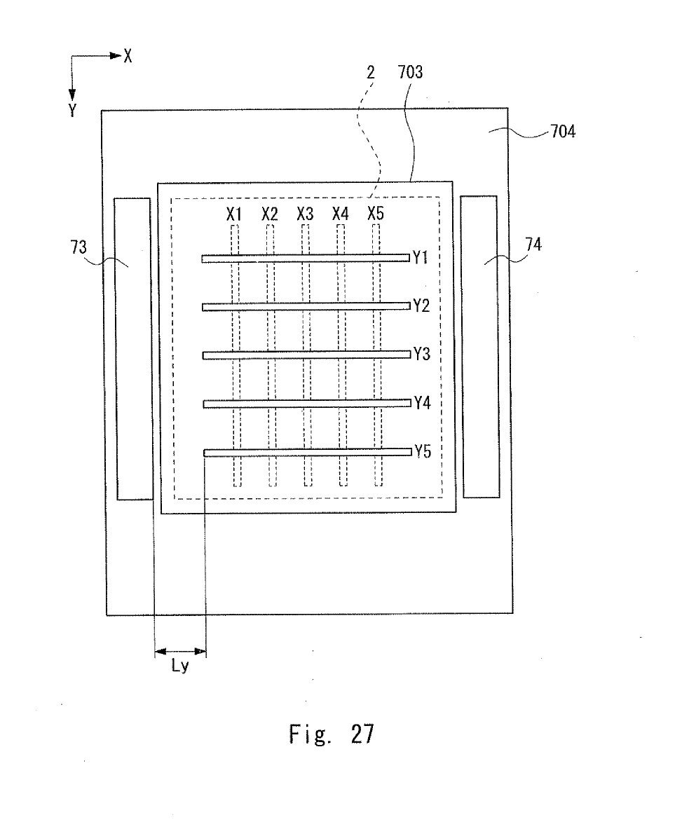

The receiving antennas 71 and 72 are disposed so as to be opposed to each other with the transmitting antenna unit 2 interposed therebetween. Each of the receiving antennas 73 and 74 is a belt-shaped antenna whose longitudinal direction coincides with the Y-direction. The receiving antennas 73 and 74 are disposed so as to be opposed to each other with the transmitting antenna unit 2 interposed therebetween. FIG. 27 shows a correspondence relation between the receiving antennas 73 and 74 and the antenna lines. The receiving antennas 73 and 74 are used to receive an electromagnetic wave when the electromagnetic wave is emitted from the antenna lines Y1 to Y5 of the transmitting antenna unit 2.

In the mobile terminal 701, distances between receiving antennas and each antenna line are equal to each other. Specifically, the distances Lx between the receiving antenna 71 and the antenna lines X1 to X5 are equal to each other. Further, the distances Lxb (not shown) between the receiving antenna 72 and the antenna lines X1 to X5 are equal to each other. Note that the distances Lx and Lxb may be equal to each other or different from each other. The distances Ly between the receiving antenna 73 and the antenna lines Y1 to Y5 are equal to each other. Further, the distances Lyb (not shown) between the receiving antenna 74 and the antenna lines Y1 to Y5 are equal to each other. Note that the distances Ly and Lyb may be equal to each other or different from each other. As a result, since the intensity of the signal that is transmitted from each transmitting antenna to the receiving antenna when the finger does not exist near the panel becomes uniform, the accuracy of the finger position detection can be improved.

Note that although a case where the mobile terminal 701 includes the receiving antennas 71 and 72 is explained in the above explanation, this case is merely an example. That is, only one of the receiving antennas 71 and 72 may be provided. Further, although a case where the mobile terminal 701 includes the receiving antennas 73 and 74 is explained in the above explanation, this case is merely an example. That is, only one of the receiving antennas 73 and 74 may be provided.

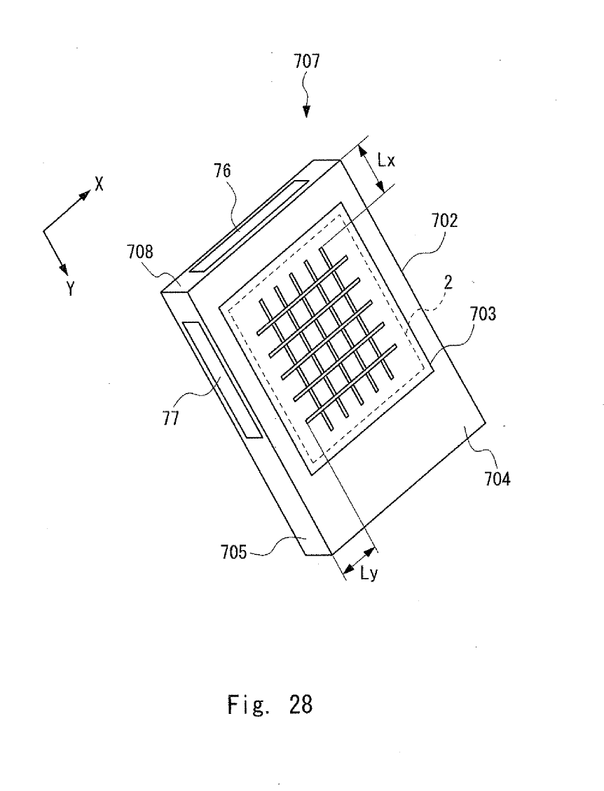

Further, the positions of the receiving antennas are not limited to the front surface on which the touch panel is disposed. Modified examples of the coordinate input device 700 are explained hereinafter. FIG. 28 is a perspective view showing an example of a mobile terminal 707 in which a touch panel in which a modified example of the coordinate input device 700 is provided is mounted as viewed from the touch panel side (front side). In FIG. 28, a receiving antenna 76 whose longitudinal direction coincides with the X-direction is disposed on a side surface 708 of the mobile terminal 707. Further, a receiving antenna 77 whose longitudinal direction coincides with the Y-direction is disposed on a side surface 705.

The side surface 708 of the mobile terminal 707 is a surface perpendicular to the Y-direction. The receiving antenna 76 whose longitudinal direction coincides with the X-direction is disposed on the side surface 708. Therefore, the distances Lx between the receiving antenna 76 and the antenna lines X1 to X5 are equal to each other.

The side surface 705 of the mobile terminal 707 is a surface perpendicular to the X-direction. The receiving antenna 77 whose longitudinal direction coincides with the Y-direction is disposed on the side surface 705. Therefore, the distances Ly between the receiving antenna 77 and the antenna lines Y1 to Y5 are equal to each other.

Therefore, similarly to the mobile terminal 701, the distances between receiving antennas and each antenna line are equal to each other in the mobile terminal 707. As a result, since the intensity of the signal that is transmitted from each transmitting antenna to the receiving antenna when the finger does not exist near the panel becomes uniform, the accuracy of the finger position detection can be improved.

Note that although a case where the number of the receiving antennas is five is explained in this exemplary embodiment, the number of the receiving antennas may be two to four or may be six or more.

Eighth exemplary embodiment Next, a coordinate input device according to an eighth exemplary embodiment is explained. In this exemplary embodiment, a method for preventing false detection in the position detection unit 45 of the detection unit 4 of the coordinate input device 100 is explained.

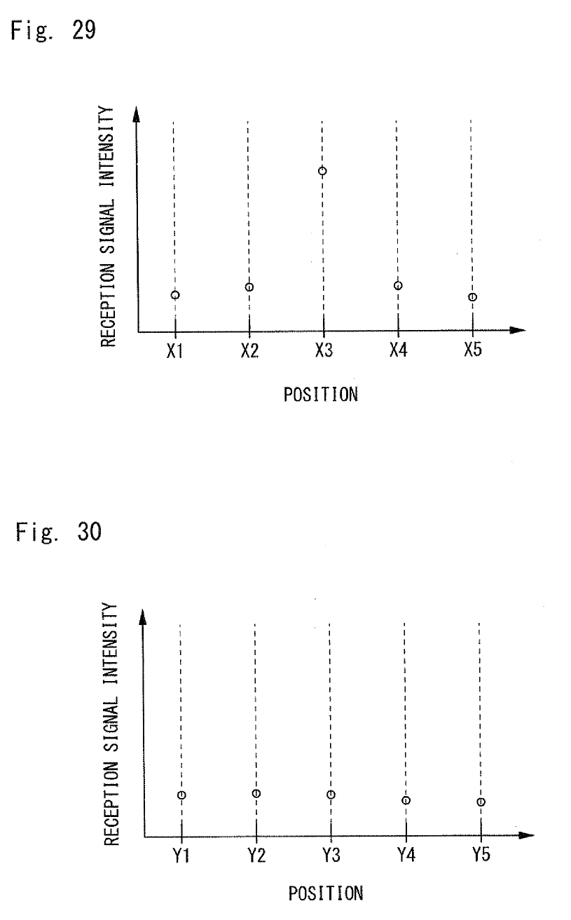

FIG. 29 shows intensities of reception signals for the antenna lines X1 to X5 according to an eighth exemplary embodiment. In this example, the signal intensity obtained by using the antenna line X3 is the largest. FIG. 30 shows intensities of reception signals for the antenna lines Y1 to Y5 according to the eighth exemplary embodiment. In this example, the signal intensities of the antenna lines Y1 to Y5 are substantially equal to each other and they have all low values.

If a finger comes close to the transmitting antenna unit 2, a peak of the signal intensity occurs in one of the antenna lines arranged in the X-direction (antenna lines X1 to X5). Further, a peak of the signal intensity occurs in one of the antenna lines arranged in the Y-direction (antenna lines Y1 to Y5). The coordinate input device 100 can detect XY-coordinates as the position of the finger by using these peaks in the X- and Y-directions.

However, in this exemplary embodiment, while a peak occurs in the signal intensities in the X-direction, no peak occurs in the signal intensities in the Y-direction. That is, in this case, it can be presumed that the peak in the signal intensities in the X-direction is not caused by a finger that has come close to the transmitting antenna unit 2. That is, when a peak occurs in only one of the signal intensities in the X- and Y-directions, it can be presumed that the peak is mistakenly detected due to a factor other than an approaching finger. Therefore, it is possible to perform no position detection for that peak.

For example, a threshold Xth is set for the signal intensity in the X-direction and a threshold Yth is set for the signal intensity in the Y-direction. Then, the position detection of a finger(s) may be performed only when the signal intensity in the X-direction is equal to or greater than the threshold Xth and the signal intensity in the Y-direction is equal to or greater than the threshold Yth.

As explained above, it is possible to prevent false position detection by performing position detection only when peaks occur in both the signal intensities in the X- and Y-directions.

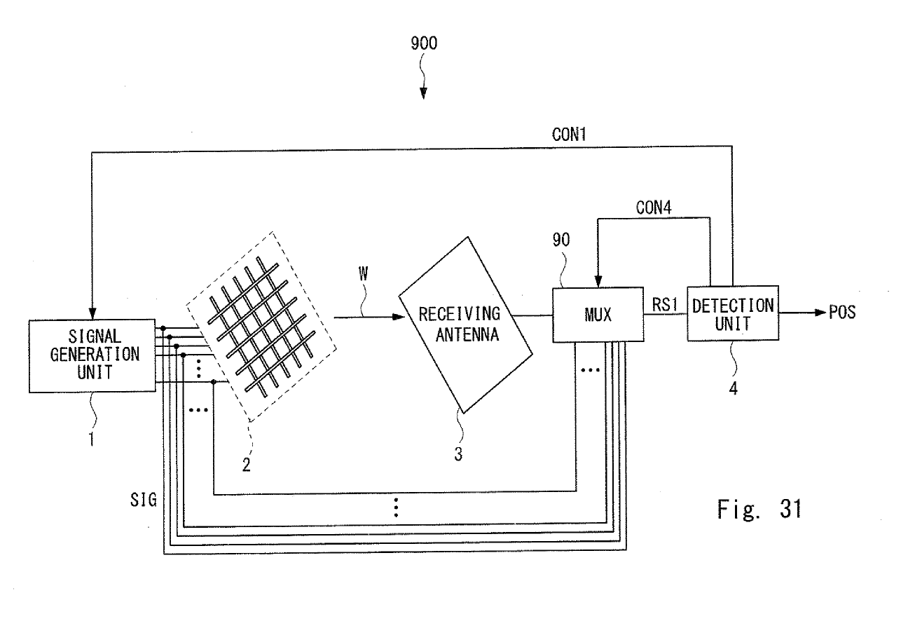

Ninth exemplary embodiment Next, a coordinate input device 900 according to a ninth exemplary embodiment is explained. FIG. 31 schematically shows a configuration of the coordinate input device 900 according to the ninth exemplary embodiment. The coordinate input device 900 is obtained by adding a multiplexer (MUX) 90 in the coordinate input device 100 according to the first exemplary embodiment. The MUX 90 is configured so that one of ten antenna lines of the transmitting antenna unit 2 and the receiving antenna 3 is connected to the detection unit 4. Note that the detection unit 4 can perform control according to a control signal CON4 as to which of the ten antenna lines of the transmitting antenna unit 2 and the receiving antenna 3 should be connected to the detection unit 4.

As shown in FIG. 9, when the distance between a finger and the transmitting antenna unit 2 is long, the coordinate input device 900 detects the position of the finger by receiving an electromagnetic wave using the receiving antenna 3. In this case, the MUX 90 connects the receiving antenna 3 with the detection unit 4.

In contrast to this, when the distance between a finger and the transmitting antenna unit 2 is short, the coordinate input device 900 detects the position of the finger by using only the antenna lines of the transmitting antenna unit 2. A mechanism for detecting the position of a finger by using only the antenna lines of the transmitting antenna unit 2 is explained hereinafter.

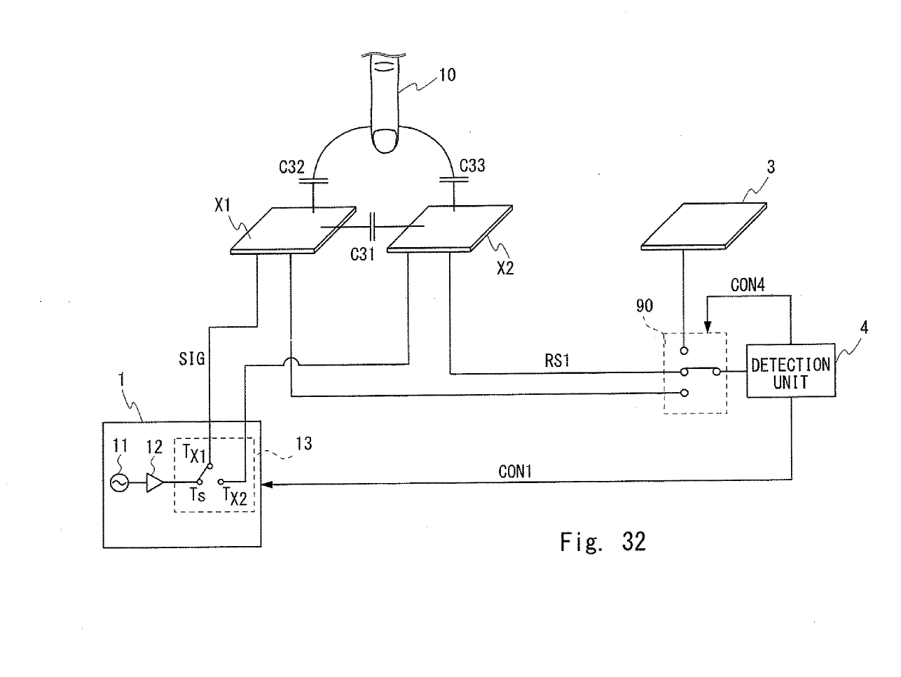

FIG. 32 shows position detection in the coordinate input device 900 when the distance between a finger 10 and the transmitting antenna unit 2 is short. For simplifying the illustration, only the antenna lines X1 and X2 of the antenna lines of the transmitting antenna unit 2 are shown in FIG. 32. When the distance between the finger and the transmitting antenna unit 2 is short, the signal generation unit 1 supplies an AC signal to the antenna line X1. Further, the MUX 90 connects the antenna line X2 with the detection unit 4. In this case, a capacitance C31 occurs between the antenna lines X1 and X2. A capacitance C32 occurs between the antenna line X1 and the finger. A capacitance C33 occurs between the finger and the antenna line X2.

When the input impedance of the detection unit 4 is represented by Zᵢₙ and the frequency of the electromagnetic wave is represented by f, the ratio between the amplitude Vₜₓ of the transmission signal at the antenna line X1 and the amplitude Vᵣₓ of the reception signal at the antenna line X2 (receiving antenna) is expressed by Expression (3) shown below.

$$\begin{matrix}[ Expression 3 ] & \\ \frac{{V}_{rx}}{{V}_{tx}} = \frac{{Z}_{in}}{{Z}_{in} + \frac{1}{2 π f} ( \frac{C 32 + C 33}{C 31 C 32 + C 31 C 33 + C 32 C 33} )} & ( 3 )\end{matrix}$$

Note that since relations “C32<<C31” and “C33<<C31” are satisfied when the finger is far away from the touch part, Expression (3) can be approximated by Expression (4) shown below.

$$\begin{matrix}[ Expression 4 ] & \\ \frac{{V}_{rx}}{{V}_{tx}} \approx \frac{{Z}_{in}}{{Z}_{in} + \frac{1}{2 π f} \frac{1}{C 31}} & ( 4 )\end{matrix}$$

In this case, the amplitude of the reception signal does not depend on the capacitances C32 and C33. That is, the amplitude of the reception signal does not depend on the position of the finger. In other words, when the finger is far away from the transmitting antenna unit 2, the intensity of the reception signal does not depend on the position of the finger. In contrast to this, when the finger is near the transmitting antenna unit 2, i.e., when the finger is in contact with the touch panel, the position detection is performed by using the above-shown Expression (1). In this way, the intensity of the reception signal changes only when the finger is located near the transmitting antenna unit 2 (when the finger is in contact with the touch panel). Therefore, it is possible to accurately determine whether the finger is located near the transmitting antenna unit 2 or not (whether the finger is in contact with the touch panel or not) by using the antenna line(s) as the receiving antenna.

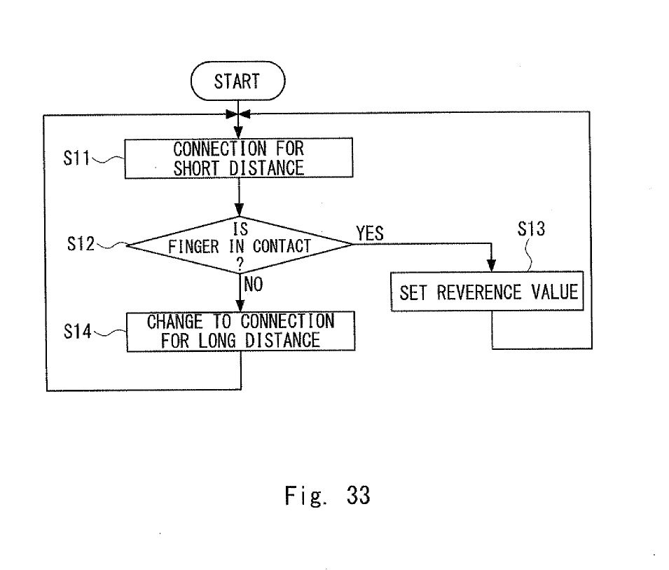

By using the accurate determination on whether the finger is located near the transmitting antenna unit 2 or not (whether the finger is in contact with the touch panel or not), the coordinate input device 900 can perform operations explained below. FIG. 33 shows a flowchart showing operations of the coordinate input device 900.

### Step S11

As shown in FIG. 32, upon startup, the coordinate input device 900 uses the antenna line(s) as the receiving antenna (connection for short distance).

### Step S12

The detection unit 4 determines whether or not a finger is located near the transmitting antenna unit 2 (whether or not a finger is in contact with the touch panel).

### Step S13

When the finger is located near the transmitting antenna unit 2 (when the finger is in contact with the touch panel), the detection unit 4 maintains the connection unchanged. Then, a measured signal value is defined as a reference value for a case where the distance between the finger and the touch panel is zero. After that, the process returns to the step S11.

### Step S14

When the finger is not located near the transmitting antenna unit 2 (when the finger is not in contact with the touch panel), the detection unit 4 changes the connection of the MUX 90 (changes to connection for long distance). As a result, the receiving antenna 3 is connected to the detection unit 4, so that the detection unit 4 can detect the position of the finger even when the finger is not located near the transmitting antenna unit 2 (even when the finger is not in contact with the touch panel). Note that the reference value for the case where the distance between the finger and the touch panel is zero is defined. Therefore, the distance between the finger and the touch panel can be accurately measured. After that, the process returns to the step S11.

Accordingly, this configuration makes it possible to calibrate (i.e., correct) the reference value when the connection for a short distance is used. Therefore, even when the finger is located away from the transmitting antenna unit (touch panel), the distance between the finger and the transmitting antenna unit (touch panel) can be accurately detected.

### Tenth Exemplary Embodiment

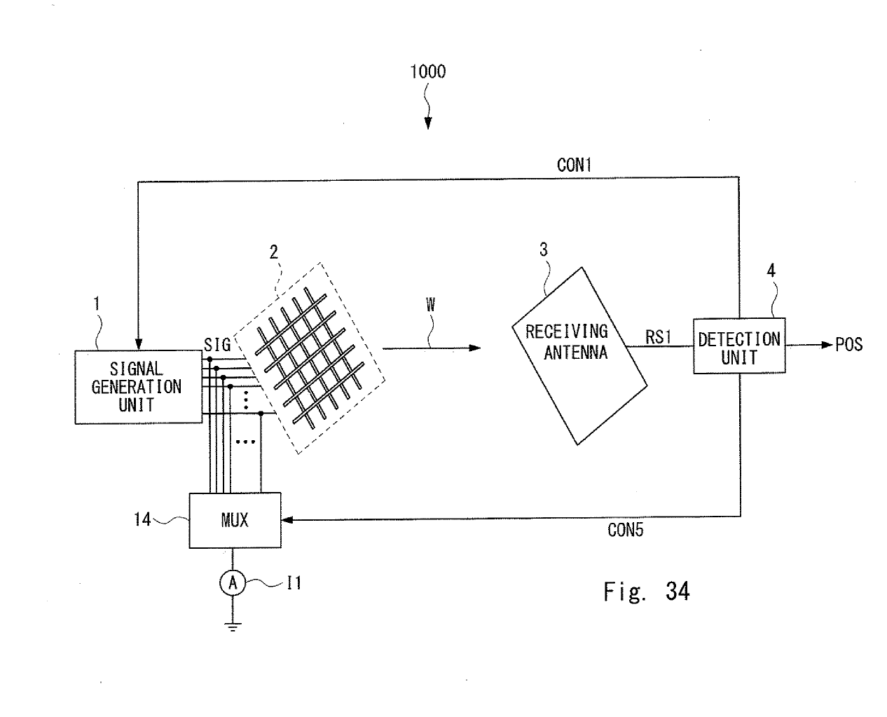

Next, a coordinate input device 1000 according to a tenth exemplary embodiment is explained. FIG. 34 schematically shows a configuration of the coordinate input device 1000 according to the tenth exemplary embodiment. The coordinate input device 1000 is obtained by adding an MUX 14 and an ammeter AMM in the coordinate input device 100 according to the first exemplary embodiment. The MUX 14 is configured so that one of ten antenna lines of the transmitting antenna unit 2 is connected to the ammeter AMM. Note that the detection unit 4 can perform control according to a control signal CON5 as to which of the antenna lines should be connected to the detection unit 4.

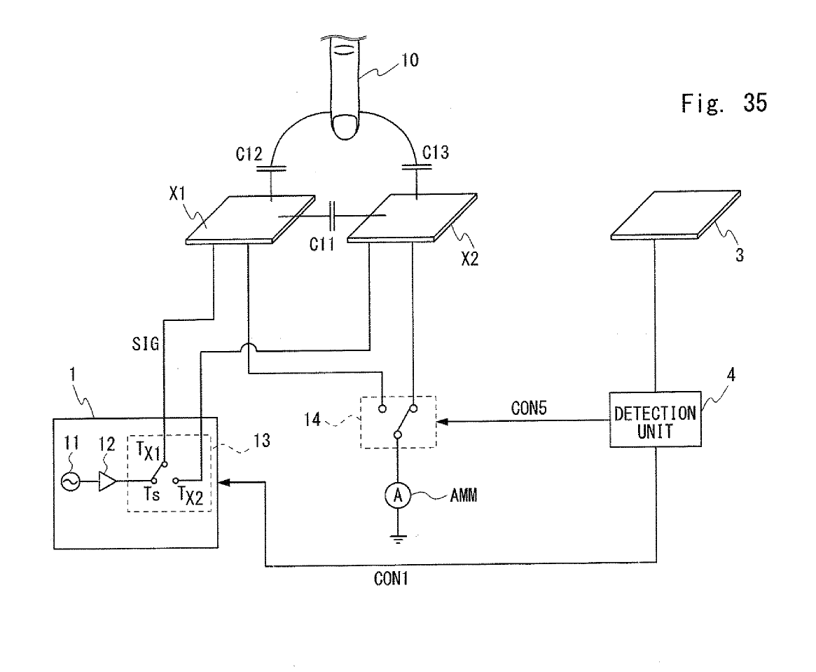

FIG. 35 shows connection of the coordinate input device 1000 when the position of a finger 10 is detected by a capacitive method. For simplifying the illustration, only the antenna lines X1 and X2 of the antenna lines of the transmitting antenna unit 2 are shown in FIG. 35. In this example, the MUX 13 connects the signal oscillation unit 11 with the antenna line X1. The MUX 14 connects the antenna line X2 with the ammeter AMM. With this connection, position detection can be performed in a capacitive method as in the case shown in FIG. 8.

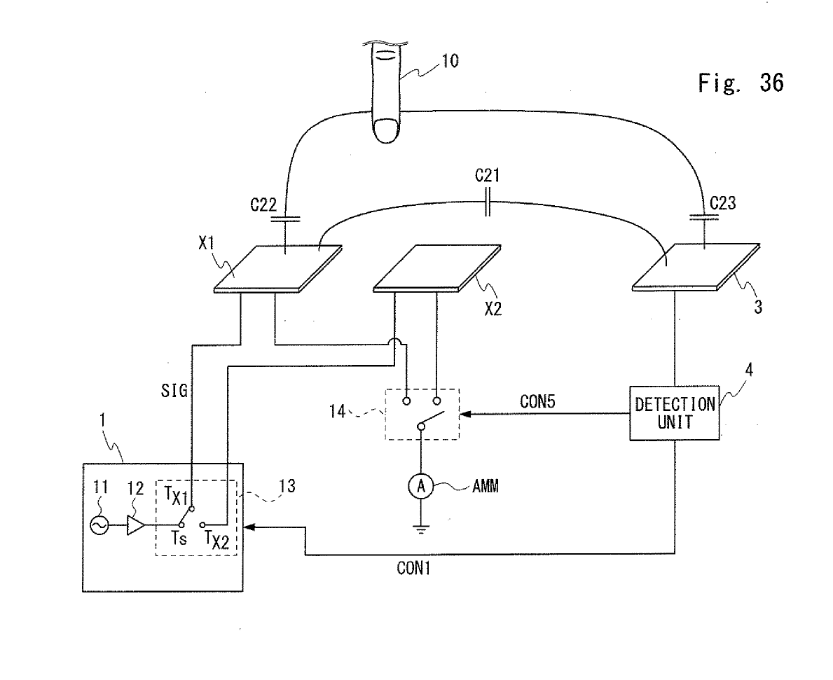

FIG. 36 shows a connection of the coordinate input device 1000 when the position of a finger 10 is detected in a state where the finger 10 is located away from the transmitting antenna unit 2. For simplifying the illustration, only the antenna lines X1 and X2 of the antenna lines of the transmitting antenna unit 2 are shown in FIG. 36. In this example, the MUX 13 connects the signal oscillation unit 11 with the antenna line X1. The MUX 14 does not connect the ammeter AMM with any antenna line. With this connection, even when the finger is located away from the transmitting antenna unit 2, position detection can be performed as in the case shown in FIG. 9.

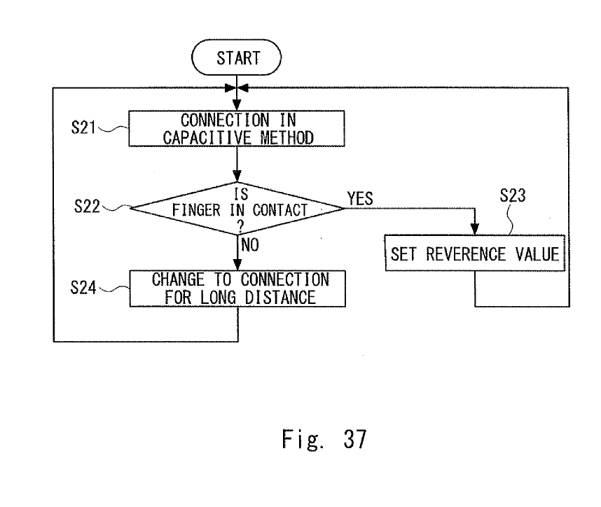

By using both the capacitive method and the position detection method for the case where the finger is located away from the transmitting antenna unit 2, the coordinate input device 1000 can perform operations explained below. FIG. 37 shows a flowchart showing operations of the coordinate input device 1000.

### Step S21

As shown in FIG. 35, upon startup, the coordinate input device 1000 establishes a connection for position detection in a capacitive method. That is, the signal generation unit 1 is connected with an antenna line (antenna line X1 in FIG. 35) by the MUX 13. Further, another antenna line (antenna line X2 in FIG. 35) is connected with the ammeter AMM by the MUX 14.

### Step S22

The detection unit 4 determines whether or not a finger is in contact with the touch panel.

### Step S23

When the finger is in contact with the touch panel, the detection unit 4 detects the position of the finger without changing the connection. Then, a measured signal value is defined as a reference value for a case where the distance between the finger and the touch panel is zero. After that, the process returns to the step S21.

### Step S24

When the finger is not in contact with the touch panel, the detection unit 4 changes the connection of the MUX 14 (changes to connection for long distance). As a result, the detection unit 4 can detect the position of the finger even when the finger is not in contact with the touch panel. Note that the reference value for the case where the distance between the finger and the touch panel is zero is defined. Therefore, the distance between the finger and the touch panel can be accurately measured. After that, the process returns to the step S21.

Accordingly, this configuration makes it possible to calibrate (i.e., correct) the reference value by using a value(s) measured in the capacitive method. Therefore, even when the finger is located away from the transmitting antenna unit (touch panel), the distance between the finger and the transmitting antenna unit (touch panel) can be accurately detected. Further, the position of the finger can be accurately detected by switching the measurement method according to whether the finger is in contact with the touch panel or not.

### Eleventh Exemplary Embodiment

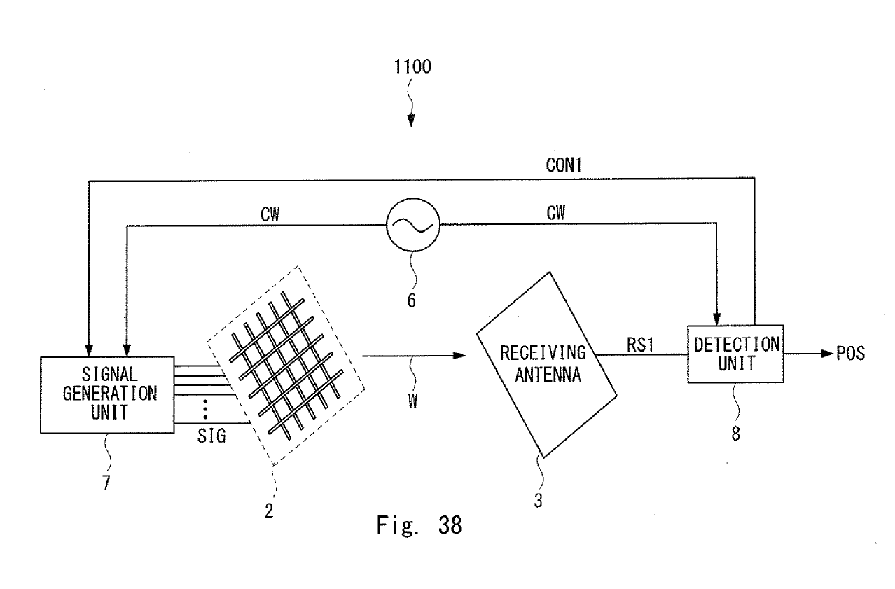

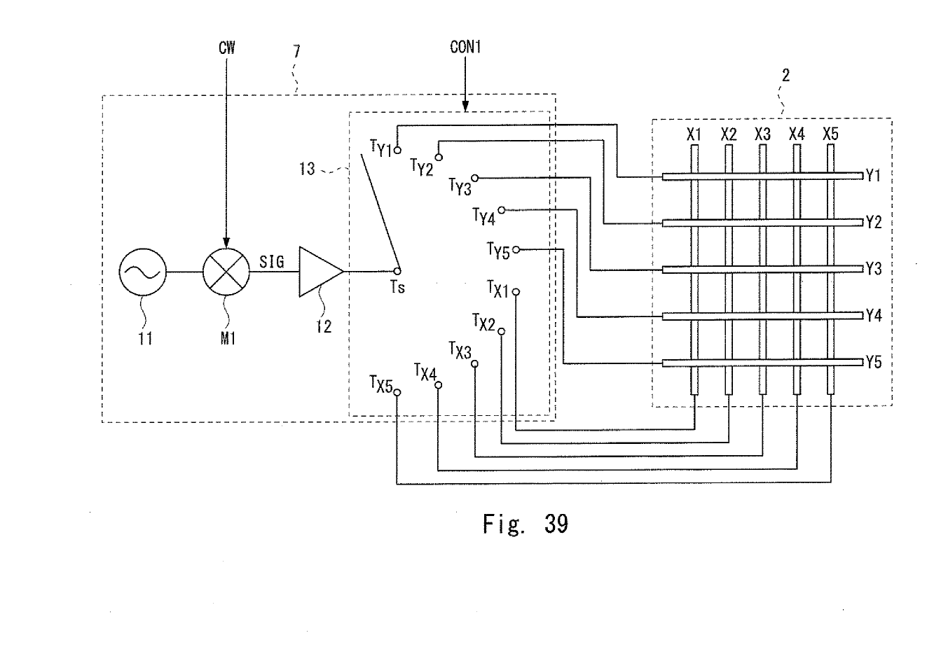

Next, a coordinate input device 1100 according to an eleventh exemplary embodiment is explained. The coordinate input device 1100 is a modified example of the coordinate input device 100 according to the first exemplary embodiment. FIG. 38 schematically shows a configuration of the coordinate input device 1100 according to the eleventh exemplary embodiment. The coordinate input device 1100 is obtained by adding a carrier-wave generation unit 6 and replacing the signal generation unit 1 and the detection unit 4 with a signal generation unit 7 and a detection unit 8, respectively, in the coordinate input device 100. The other configuration of the coordinate input device 1100 is similar to that of the coordinate input device 100.

FIG. 39 schematically shows a configuration of the signal generation unit 7. The signal generation unit 7 is obtained by adding a mixer M1 in the signal generation unit 1. The mixer M1 is interposed between the signal oscillation unit 11 and the amplifier 12. The mixer M1 mixes the AC signal SIG supplied from the signal oscillation unit 11 with a carrier wave CW supplied from the carrier-wave generation unit 6, and outputs the mixed signal to the amplifier 12. The other configuration of the signal generation unit 7 is similar to that of the signal generation unit 1, and therefore its explanation is omitted.

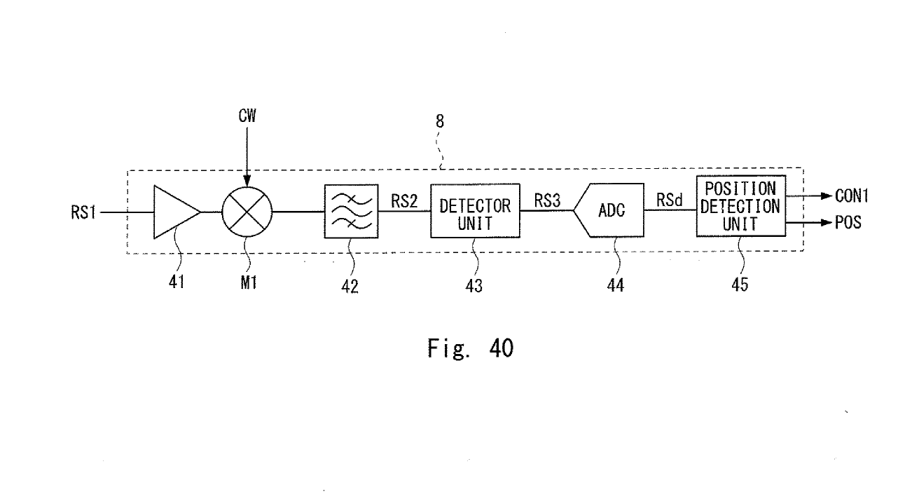

FIG. 40 schematically shows a configuration of the detection unit 8. The detection unit is obtained by adding a mixer M2 in the detection unit 4. The mixer M2 is interposed between the amplifier 41 and the filter 42. The mixer M2 mixes a reception signal with the carrier wave CW, and converts the mixed signal into a reception signal having the same frequency component as that of the AC signal SIG of the signal oscillation unit 11. The other configuration of the detection unit 8 is similar to that of the detection unit 4, and therefore its explanation is omitted.

According to this configuration, the frequency selectivity can be improved without using a filter having a sharp characteristic for the filter 42 in comparison to the case where the AC signal is directly transmitted. As a result, it is advantageous in that the tolerance to noises can be improved.

Further, the carrier-wave generation unit 6 can periodically change the frequency of the carrier wave CW output therefrom within a specific range. Further, the AC signal output from the signal generation unit 7 may also be periodically changed within a specific range. This frequency change may be performed in such a manner that one cycle of the frequency change is performed within the period during which one antenna line is selected. Alternatively, one cycle of the frequency change may be performed every time the ten antenna lines are selected.

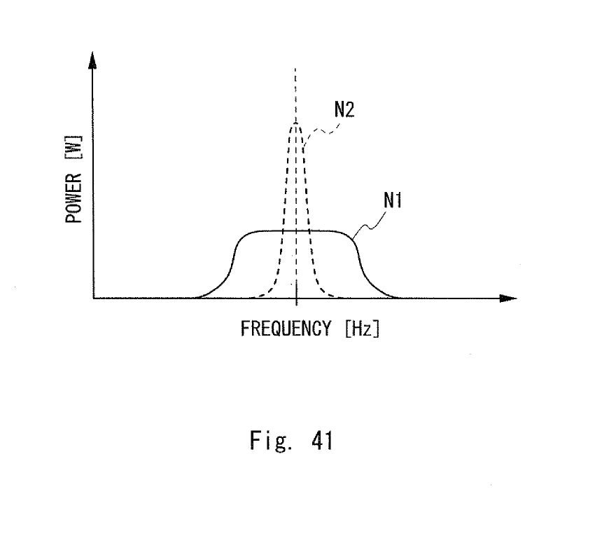

FIG. 41 shows a frequency spectrum of noises when frequency(s) of the carrier wave and the AC signal is changed. By changing the frequency as described above, it is possible to converts the frequency spectrum of noises emitted from the transmitting antenna unit 2 into one that spreads over a specific frequency range (solid line N1 in FIG. 41). Therefore, it is possible to prevent noises from being concentrated at a specific frequency (broken line N2 in FIG. 41). As a result, it is possible to reduce the effect of emitted noises to other apparatuses.

### Twelfth Exemplary Embodiment

Next, a coordinate input device according to a twelfth exemplary embodiment is explained. The coordinate input device according to the twelfth exemplary embodiment has a similar configuration to that of the coordinate input device 100 according to the first exemplary embodiment. In this exemplary embodiment, an application example in which the antenna line through which the AC signal is transmitted is fixed to one antenna line is explained.

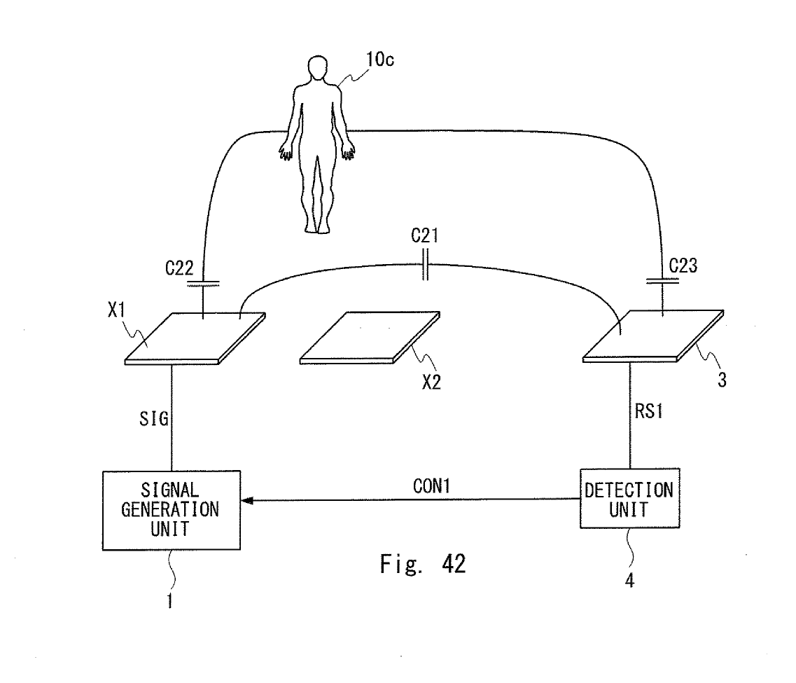

In the above-described exemplary embodiments, the antenna lines through which the AC signal is transmitted are switched in a time series manner. In contrast to this, the AC signal is continuously transmitted from one antenna line in this exemplary embodiment. FIG. 42 schematically shows position detection in the coordinate input device according to the twelfth exemplary embodiment. For simplifying the illustration, only the antenna lines X1 and X2 of the antenna lines of the transmitting antenna unit 2 are shown in FIG. 42. Further, the antennal line X1 is used as the continuously-used antenna in FIG. 42.

In this exemplary embodiment, while an AC signal is continuously transmitted through, for example, the antenna line X1, temporal changes in the intensity of the reception signal are observed. Note that if a human body 10c exists in the path through which the signal is transmitted (i.e., between the transmitting antenna unit 2 and the receiving antenna 3), the transfer characteristic of the signal changes with time due to the pulses (blood beats) of the human body 10c or the like even when the original transmission signal has a regular sine wave. Therefore, the above-described temporal changes are superimposed in the reception signal, and the reception signal has such a waveform that its amplitude changes with time. Accordingly, it is possible to detect the pulses (blood beats) of the human body 10c by extracting a low frequency component(s) on the order of several Hz from the reception signal through a filtering process.

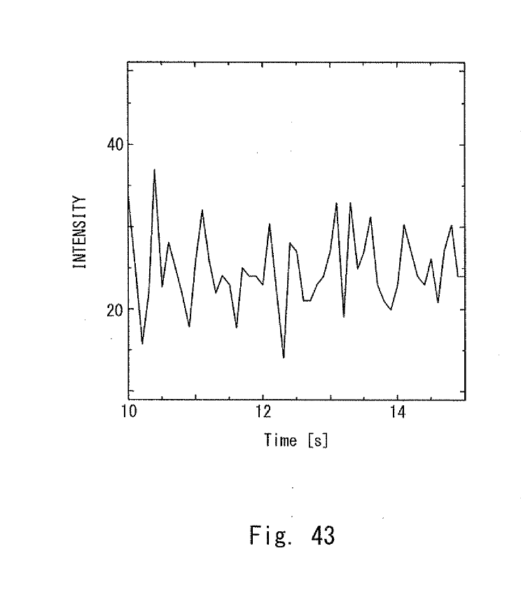

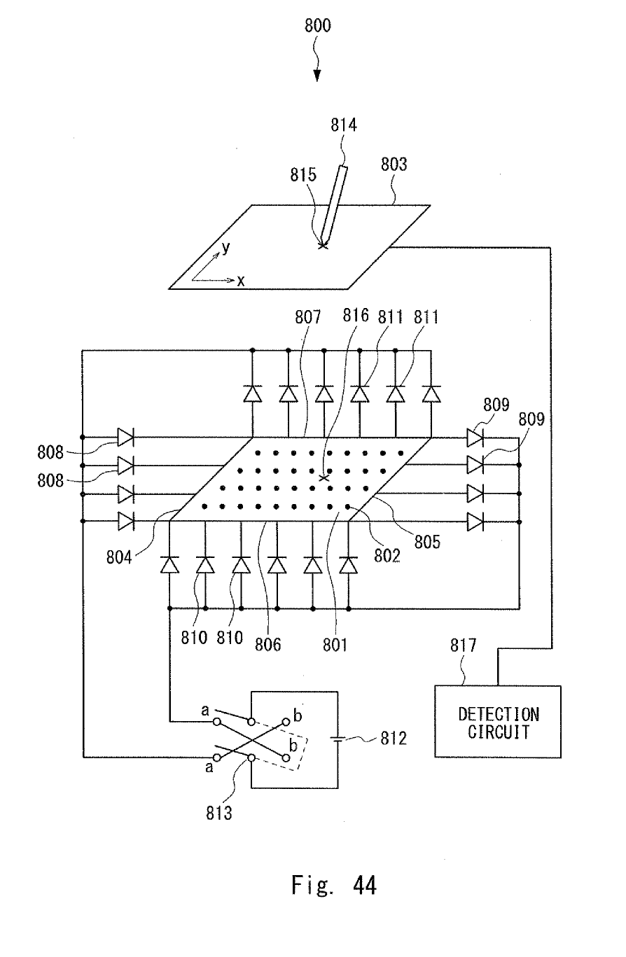

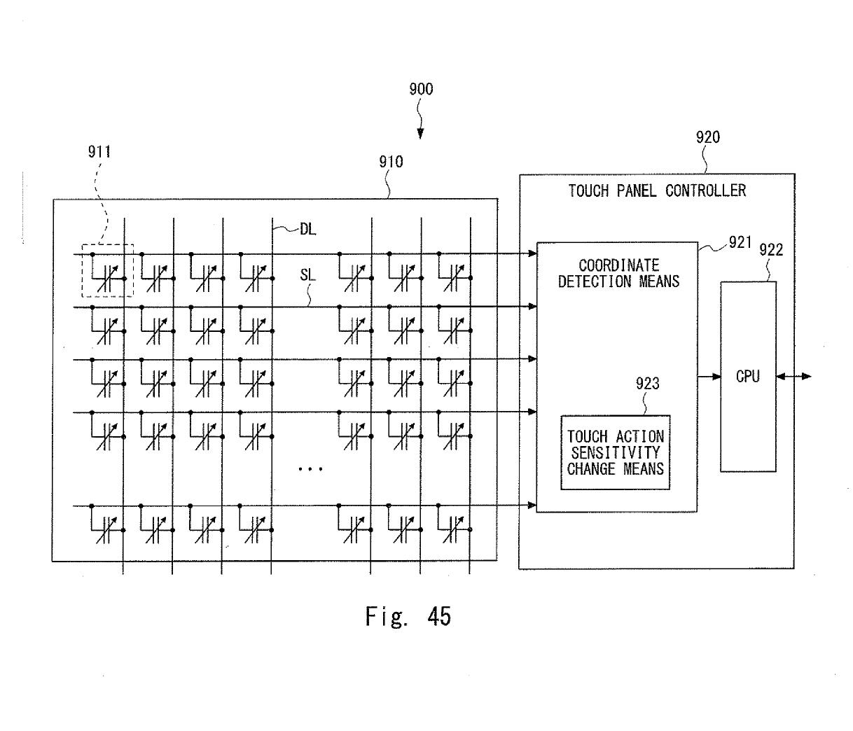

FIG. 43 shows an example of a waveform of low frequency components extracted from the reception signal. According to this exemplary embodiment, it is possible to obtain a waveform component(s) indicating the pulses of a human body as described above. As a result, for example, pulse data can be used for health monitoring of a user of the mobile terminal and the like. Further, it is possible to determine whether the conductor that is approaching to the coordinate input device according to this exemplary embodiment is a living being or not by detecting the presence/absence of pulses.

### Other Exemplary Embodiments

Note that the present invention is not limited to the above-described embodiments, and they can be modified as desired without departing from the spirit and scope of the present invention. For example, although examples in which the transmitting antenna unit is incorporated into the touch panel and the receiving antenna is disposed in the other area are explained in the above-described exemplary embodiments, these configurations are merely examples. For example, a coordinate input device similar to the coordinate input devices according to the above-described exemplary embodiments can be realized even when one or a plurality of receiving antennas are incorporated in the touch panel and a configuration equivalent to that of the antenna lines of the transmitting antenna unit is disposed in the other area.

Needless to say, a plurality of receiving antennas can be provided in the above-described coordinate input device 500. For example, a plurality of antennas and a multiplexer may be provided in the coordinate input device 500 as in the case of the coordinate input device 600 or 700. Further, it is possible to combine at least one or all of the setting of a setting value(s) (coordinate input device 900 according to Ninth exemplary embodiment), the detection method switching (coordinate input device 1000 according to Tenth exemplary embodiment), and the use of a carrier wave (coordinate input device 1100 according to Eleventh exemplary embodiment) with the coordinate input device 500.

Needless to say, a plurality of receiving antennas can be provided in each of the above-described coordinate input devices 900, 1000, and 1100. For example, a plurality of antennas and a multiplexer may be provided in each of the above-described coordinate input devices 900, 1000, and 1100 as in the case of the coordinate input device 600 or 700. The setting of a setting value(s) (coordinate input device 900 according to Ninth exemplary embodiment), the detection method switching (coordinate input device 1000 according to Tenth exemplary embodiment), and the use of a carrier wave (coordinate input device 1100 according to Eleventh exemplary embodiment) can be combined as desired and used in a combined fashion.

Needless to say, the techniques explained in the above-described exemplary embodiments can be applied to the coordinate input devices 500, 600, 700, 900, 1000 and 1100, and to the above-described other coordinate input devices obtained by combining those coordinate input devices. That is, the improvement of the detection accuracy by the use of a polynomial expression (Second exemplary embodiment) or the improvement of the detection accuracy by the use of a predicted distribution (Third exemplary embodiment) can be applied as desired to the coordinate input devices 500, 600, 700, 900, 1000 and 1100, and to the above-described other coordinate input devices obtained by combining those coordinate input devices. Further, at least one or all of the improvement of the detection accuracy by the shapes of the antenna lines and the receiving antenna (Fourth exemplary embodiment), the prevention of false detection (Eighth exemplary embodiment), and the pulse measurement of a human body (Twelfth exemplary embodiment) can be applied to the coordinate input devices 500, 600, 700, 900, 1000 and 1100, and to the above-described other coordinate input devices obtained by combining those coordinate input devices.

The above-described exemplary embodiments are explained on the assumption the X- and Y-directions are orthogonal to each other in order to explain the configurations of the coordinate input devices and the mobile terminals. However, the X- and Y-directions are not necessarily orthogonal to each other. That is, the X- and Y-directions may intersect at angles other than the right angle.

The present invention made by the inventors has been explained above in a specific manner based on embodiments. However, the present invention is not limited to the above-described embodiments, and needless to say, various modifications can be made without departing from the spirit and scope of the present invention.

The whole or part of the exemplary embodiments disclosed above can be described as, but not limited to, the following supplementary notes.

### (Supplementary Note 1)

A coordinate input device comprising: a signal generation unit that outputs an AC signal; a first transmission/reception unit comprising a plurality of first antennas that transmit/receive a signal according to the AC signal; a second transmission/reception unit comprising one or a plurality of second antennas that transmit/receive the signal to/from the first transmission/reception unit; and a detection unit that, when the first transmission/reception unit transmits/receives the signal, obtains an intensity distribution of the signal corresponding to positions of the plurality of first antennas and detects a detection position according to a position of a peak of the intensity distribution.

### (Supplementary Note 2)

The coordinate input device described in Supplementary note 1, wherein: the signal generation unit outputs the AC signal to one of the plurality of first antennas of the first transmission/reception unit; the signal is transmitted from the one of the plurality of first antennas to which the AC signal is supplied; and the second transmission/reception unit receives the signal through the second antenna.

### (Supplementary Note 3)

The coordinate input device described in Supplementary note 1, wherein: the signal generation unit outputs the AC signal to the second transmission/reception unit; the signal is transmitted from the second transmission/reception unit through the second antenna; and the signal is received through one of the plurality of first antennas.

### (Supplementary Note 4)

The coordinate input device described in Supplementary note 1, wherein: the detection unit receives the signal through an electric conductor; and the detection position indicates a position of the electric conductor.

### (Supplementary Note 5)

The coordinate input device described in Supplementary note 4, wherein the electric conductor is a human body.

### (Supplementary Note 6)

The coordinate input device described in Supplementary note 1, wherein the detection unit detects one or a plurality of detection positions according to one or a plurality of peaks.

### (Supplementary Note 7)

The coordinate input device described in Supplementary note 1, wherein: the plurality of first antennas are arranged in a predetermined direction; the detection unit approximates an intensity of the signal detected for the plurality of first antennas by using a polynomial expression including a position in the predetermined direction as a variable; and a position in the predetermined direction at which a value of the polynomial expression is maximized is detected as the detection position.

### (Supplementary Note 8)

The coordinate input device described in Supplementary note 1, wherein: the plurality of first antennas are arranged in a predetermined direction; the detection unit applies a predicted distribution including a position in the predetermined direction as a variable to an intensity of the signal detected for the plurality of first antennas; and a position in the predetermined direction at which a correlation with the predicted distribution is maximized is detected as the detection position.

### (Supplementary Note 9)

The coordinate input device described in Supplementary note 2, wherein the detection unit detects a distance between an electric conductor inserted between the first antenna of the first transmission/reception unit and the second antenna of the second transmission/reception unit and the first antenna of the first transmission/reception unit based on an intensity of the signal at the detection position.

### (Supplementary Note 10)

The coordinate input device described in Supplementary note 9, wherein: the signal generation unit outputs a plurality of types of AC signals having different frequencies; the detection unit detects a position that is in parallel with a plane including the first antennas when the signal generation unit is outputting an AC signal having a first frequency; and the detection unit detects a position that is perpendicular to the plane including the first antennas when the signal generation unit is outputting an AC signal having a second frequency higher than the first frequency.

### (Supplementary Note 11)

The coordinate input device described in Supplementary note 10, wherein

the detection unit receives the signal transmitted from one of the plurality of first antennas through another one of the plurality of first antennas by the second transmission/reception unit, and

the detection unit sets, when an intensity of the received signal is larger than a predetermined value, the intensity of the received signal as a reference intensity for a case where a distance between the electric conductor and the first transmission/reception unit is zero.

### (Supplementary Note 12)

The coordinate input device described in Supplementary note 9, wherein: the first transmission/reception unit is incorporated into a capacitive touch panel; and all or at least two of the plurality of first antennas function as electrodes of the capacitive touch panel.

### (Supplementary Note 13)

The coordinate input device described in Supplementary note 12, wherein: the signal generation unit outputs the AC signal to one of the plurality of first antennas of the first transmission/reception unit in parallel with position detection of the capacitive touch panel, or outputs the AC signal thereto independently; and the detection unit compares intensities of the signal detected for the plurality of first antennas with each other and thereby detects the detection position.

### (Supplementary Note 14)

The coordinate input device described in Supplementary note 1, further comprising a carrier wave generation unit that outputs a carrier wave to the signal generation unit and the detection unit, wherein: the signal generation unit mixes the AC signal with the carrier wave and outputs the mixed signal; the plurality of first antennas of the first transmission/reception unit transmit the signal according to the mixed AC signal and the carrier wave; and the detection unit detects an intensity of the signal corresponding to the AC signal from which the carrier wave is removed for each of the plurality of first antennas.

### (Supplementary Note 15)

The coordinate input device described in Supplementary note 14, wherein the carrier wave generation unit outputs a carrier wave whose frequency changes with time.

### (Supplementary Note 16)

The coordinate input device described in Supplementary note 1, further comprising a plurality of second transmission/reception units, wherein the detection unit detects an intensity of the signal received through the second antenna of one of the plurality of second transmission/reception units for each of the plurality of first antennas, and detects the detection position according to a position of the first antenna with which the intensity of the detected signal is maximized.

### (Supplementary Note 17)

The coordinate input device described in Supplementary note 1, further comprising a plurality of second transmission/reception units, wherein the detection unit detects an intensity of the signal received through the second antenna of one of the plurality of second transmission/reception units for each of the plurality of first antennas; after detecting the detection position by comparing intensities of the detected signals, detects an intensity of the signal received through the second antenna of another one of the plurality of second transmission/reception units for each of the plurality of first antennas; and detects the detection position by comparing intensities of the detected signals.

### (Supplementary Note 18)

The coordinate input device described in Supplementary note 1, wherein: the plurality of first antennas comprises a first antenna set including a plurality of antennas arranged in a first direction and a second antennal set including a plurality of antennas arranged in a second direction different from the first direction; and the detection unit detects an intensity of the signal received in the second transmission/reception unit for each of the plurality of antennas of the first antenna set, compares the detected intensities of the signal and thereby detects as a first position, detects an intensity of the signal received in the second transmission/reception unit for each of the plurality of antennas of the second antenna set, compares the detected intensities of the signal and thereby detects as a second position, and detects coordinates represented by the first and second positions as the detection position.

### (Supplementary Note 19)

The coordinate input device described in Supplementary note 18, wherein when the first position detected by using the plurality of antennas of the first antenna set does not match the second position detected by using the plurality of antennas of the second antenna set, the detection unit invalidates the first and second detection positions.

### (Supplementary Note 20)

The coordinate input device described in Supplementary note 18, further comprising a plurality of second transmission/reception units, wherein the detection unit detects an intensity of the signal received in one of the second transmission/reception units for each of the plurality of first antennas, and compares the detected intensities of the signal and thereby detects the detection position.

### (Supplementary Note 21)

The coordinate input device described in Supplementary note 1, wherein the detection unit extracts a predetermined frequency component from an intensity of the signal received in the second transmission/reception unit for one of the plurality of first antennas, and detects a state change of an electric conductor inserted between the first antennal of the first transmission/reception unit and the second antenna of the second transmission/reception unit.

### (Supplementary Note 22)

The coordinate input device described in Supplementary note 20, wherein the electric conductor is a human body, and the detection unit detects a pulse from an intensity change of the predetermined low frequency component.

### (Supplementary Note 23)

The coordinate input device described in Supplementary note 22, wherein it is determined whether the electric conductor is a living being or not based on presence/absence of a pulse.

### (Supplementary Note 24)

The coordinate input device described in Supplementary note 1, wherein a wavelength of the AC signal is at least ten times as large as a size of the first and second transmission/reception units.

### (Supplementary Note 25)

The coordinate input device described in Supplementary note 1, wherein each of the plurality of antennas is a linear antenna disposed along a main surface of the first transmission/reception unit, and the second transmission/reception unit is a planar antenna.

### (Supplementary Note 26)

A coordinate input device that detects a position of an electric conductor, comprising: a signal generation unit that outputs an AC signal; a first transmission/reception unit comprising a plurality of first antennas that transmit/receive a signal according to the AC signal; one or a plurality of second transmission/reception units comprising second antennas that transmit/receive the signal to/from the first transmission/reception unit; and a detection unit that, when the first transmission/reception unit transmits/receives the signal, obtains an intensity distribution of the signal corresponding to positions of the plurality of first antennas and detects the position of the electric conductor according to a position of a peak of the intensity distribution, the electric conductor being inserted between the plurality of first antennas of the first transmission/reception unit and one or a plurality of second antennas of the second transmission/reception unit.

### (Supplementary Note 27)

A mobile terminal comprising a coordinate input device described in Supplementary note 26 incorporated therein, wherein the plurality of first antennas of the first transmission/reception unit are disposed only on a first surface, and the second antenna of each of the plurality of second transmission/reception units is disposed on the first surface or a surface different from the first surface.

### (Supplementary Note 28)

The coordinate input device described in Supplementary note 25, wherein: the plurality of second transmission/reception units comprise a third transmission/reception unit and a fourth transmission/reception unit; the third transmission/reception unit is disposed away from the first transmission/reception unit in the first direction so that the third transmission/reception unit is disposed the same distance away from each of the plurality of first antennas; the fourth transmission/reception unit is disposed away from the first transmission/reception unit in the second direction so that the fourth transmission/reception unit is disposed the same distance away from each of the plurality of second antennas and the detection unit detects an intensity of the signal for each of the plurality of first antennas by the third transmission/reception unit and detects an intensity of the signal for each of the plurality of second antennas by the fourth transmission/reception unit.

### (Supplementary Note 29)

A mobile terminal comprising a coordinate input device described in Supplementary note 1 incorporated therein. in its entirety by reference.

The above-described embodiments can be combined as appropriate or desirable by one of ordinary skill in the art.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

### REFERENCE SIGNS LIST

1, 5, 7 SIGNAL GENERATION UNIT
2 TRANSMITTING ANTENNA UNIT
3 RECEIVING ANTENNA
4 DETECTION UNIT
6 CARRIER-WAVE GENERATION UNIT
8 DETECTION UNIT
10 FINGER
10A LEFT HAND
10B RIGHT HAND
10C HUMAN BODY
11, 51 SIGNAL OSCILLATION UNIT
12 AMPLIFIER
13, 14, 60, 70, 90 MUX
41 AMPLIFIER
42 FILTER
43 DETECTOR UNIT
44 A/D CONVERTER
45 POSITION DETECTION UNIT
61-63 RECEIVING ANTENNA
71-77 RECEIVING ANTENNA
100, 500, 600, 700, 900, 1000, 1100 COORDINATE INPUT DEVICE
101, 601, 701, 707 MOBILE TERMINAL
102, 602, 702 HOUSING
103, 603, 703 TOUCH PANEL
604, 704 FRONT SURFACE
605, 705, 708 SIDE SURFACE
606 REAR SURFACE
800 TOUCH PANEL
801 TRANSPARENT RESISTIVE SHEET
802 PROTRUSION
803 TRANSPARENT ELECTRODE SHEET
804-807 SIDE
808-811 DIODE GROUP
812 POWER SUPPLY
813 SWITCH
814 PEN
815, 816 POINT
817 DETECTION CIRCUIT
900 COORDINATE INPUT DEVICE
910 TOUCH PANEL
920 TOUCH PANEL CONTROLLER
911 SENSOR
921 COORDINATE DETECTION MEANS
922 CPU
923 TOUCH ACTION SENSITIVITY CHANGE MEANS
CON1-CON5 CONTROL SIGNAL
CW CARRIER WAVE
DL DRIVE LINE
E11, E12 ELECTRODE
AMM AMMETER
M1, M2 MIXER
RS1-RS3, RSD RECEPTION SIGNAL
SIG, SIG1, SIG2 AC SIGNAL
S1 OSCILLATOR
SL SENSE LINE
T_{S} TERMINAL
T_{X1}-T_{X5} TERMINAL
T_{Y1}-T_{Y5} TERMINAL
X1-X5, Y1-Y5 ANTENNA LINE

What is claimed is:

1. A coordinate input device comprising:
a signal generation unit that outputs an AC signal;
a first transmission/reception unit comprising a plurality of first antennas that transmit/receive a signal according to the AC signal;
a second transmission/reception unit comprising one or a plurality of second antennas that transmit/receive the signal to/from the first transmission/reception unit; and
a detection unit that, when the first transmission/reception unit transmits/receives the signal, obtains an intensity distribution of the signal corresponding to positions of the plurality of first antennas and detects a detection position according to a position of a peak of the intensity distribution.

2. The coordinate input device according to claim 1, wherein
the signal generation unit outputs the AC signal to one of the plurality of first antennas of the first transmission/reception unit,
the signal is transmitted from the one of the plurality of first antennas to which the AC signal is supplied, and
the second transmission/reception unit receives the signal through the second antenna.

3. The coordinate input device according to claim 1, wherein
the signal generation unit outputs the AC signal to the second transmission/reception unit,
the signal is transmitted from the second transmission/reception unit through the second antenna, and
the signal is received through one of the plurality of first antennas.

4. The coordinate input device according to claim 1, wherein
the detection unit receives the signal through an electric conductor, and
the detection position indicates a position of the electric conductor.

5. The coordinate input device according to claim 4, wherein the electric conductor is a human body.

6. The coordinate input device according to claim 1, wherein the detection unit detects one or a plurality of detection positions according to one or a plurality of peaks.

7. The coordinate input device according to claim 1, wherein
the plurality of first antennas are arranged in a predetermined direction,
the detection unit approximates an intensity of the signal detected for the plurality of first antennas by using a polynomial expression including a position in the predetermined direction as a variable, and
a position in the predetermined direction at which a value of the polynomial expression is maximized is detected as the detection position.

8. The coordinate input device according to claim 1, wherein
the plurality of first antennas are arranged in a predetermined direction,
the detection unit applies a predicted distribution including a position in the predetermined direction as a variable to an intensity of the signal detected for the plurality of first antennas, and
a position in the predetermined direction at which a correlation with the predicted distribution is maximized is detected as the detection position.

9. The coordinate input device according to claim 2, wherein the detection unit detects a distance between an electric conductor inserted between the first antenna of the first transmission/reception unit and the second antenna of the second transmission/reception unit and the first antenna of the first transmission/reception unit based on an intensity of the signal at the detection position.

10. The coordinate input device according to claim 9, wherein
the signal generation unit outputs a plurality of types of AC signals having different frequencies,
the detection unit detects a position that is in parallel with a plane including the first antennas when the signal generation unit is outputting an AC signal having a first frequency, and
the detection unit detects a position that is perpendicular to the plane including the first antennas when the signal generation unit is outputting an AC signal having a second frequency higher than the first frequency.

11. The coordinate input device according to claim 10, wherein
the detection unit receives the signal transmitted from one of the plurality of first antennas through another one of the plurality of first antennas by the second transmission/reception unit, and
the detection unit sets, when an intensity of the received signal is larger than a predetermined value, the intensity of the received signal as a reference intensity for a case where a distance between the electric conductor and the first transmission/reception unit is zero.

12. The coordinate input device according to claim 9, wherein
the first transmission/reception unit is incorporated into a capacitive touch panel, and
all or at least two of the plurality of first antennas function as electrodes of the capacitive touch panel.

13. The coordinate input device according to claim 12, wherein
the signal generation unit outputs the AC signal to one of the plurality of first antennas of the first transmission/reception unit in parallel with position detection of the capacitive touch panel, or outputs the AC signal thereto independently, and
the detection unit compares intensities of the signal detected for the plurality of first antennas with each other and thereby detects the detection position.

14. The coordinate input device according to claim 1, further comprising a carrier wave generation unit that outputs a carrier wave to the signal generation unit and the detection unit, wherein
the signal generation unit mixes the AC signal with the carrier wave and outputs the mixed signal,
the plurality of first antennas of the first transmission/reception unit transmit the signal according to the mixed AC signal and the carrier wave, and
the detection unit detects an intensity of the signal corresponding to the AC signal from which the carrier wave is removed for each of the plurality of first antennas.

15. The coordinate input device according to claim 14, wherein the carrier wave generation unit outputs a carrier wave whose frequency changes with time.

16. The coordinate input device according to claim 1, further comprising a plurality of second transmission/reception units, wherein
the detection unit detects an intensity of the signal received through the second antenna of one of the plurality of second transmission/reception units for each of the plurality of first antennas, and compares the detected intensities of the signal and thereby detects the detection position.

17. The coordinate input device according to claim 1, further comprising a plurality of second transmission/reception units, wherein
the detection unit detects an intensity of the signal received through the second antenna of one of the plurality of second transmission/reception units for each of the plurality of first antennas; after detecting the detection position by comparing intensities of the detected signals, detects an intensity of the signal received through the second antenna of another one of the plurality of second transmission/reception units for each of the plurality of first antennas; and detects the detection position by comparing intensities of the detected signals.

18. The coordinate input device according to claim 1, wherein
the plurality of first antennas comprises a first antenna set including a plurality of antennas arranged in a first direction and a second antennal set including a plurality of antennas arranged in a second direction different from the first direction, and
the detection unit detects an intensity of the signal received in the second transmission/reception unit for each of the plurality of antennas of the first antenna set, compares the detected intensities of the signal and thereby detects as a first position, detects an intensity of the signal received in the second transmission/reception unit for each of the plurality of antennas of the second antenna set, compares the detected intensities of the signal and thereby detects as a second position, and detects coordinates represented by the first and second positions as the detection position.

19. A coordinate input device that detects a position of an electric conductor, comprising:
a signal generation unit that outputs an AC signal;
a first transmission/reception unit comprising a plurality of first antennas that transmit/receive a signal according to the AC signal;
one or a plurality of second transmission/reception units comprising second antennas that transmit/receive the signal to/from the first transmission/reception unit; and
a detection unit that, when the first transmission/reception unit transmits/receives the signal, obtains an intensity distribution of the signal corresponding to positions of the plurality of first antennas and detects the position of the electric conductor according to a position of a peak of the intensity distribution, the electric conductor being inserted between the plurality of first antennas of the first transmission/reception unit and one or a plurality of second antennas of the second transmission/reception unit.

20. A mobile terminal comprising a coordinate input device according to claim 18 incorporated therein, wherein
the plurality of first antennas of the first transmission/reception unit are disposed only on a first surface, and the second antenna of each of the plurality of second transmission/reception units is disposed on the first surface or a surface different from the first surface.
